(19) United States
(12) Patent Application Publication
(10) Pub. No.: US 2013/0298038 A1
(43) Pub. Date: Nov. 7, 2013

(54) TRENDING OF AGGREGATED PERSONALIZED INFORMATION STREAMS AND MULTI-DIMENSIONAL GRAPHICAL DEPICTION THEREOF

(71) Applicant: BOTTLENOSE, INC., Sherman Oaks, CA (US)

(72) Inventors: Nova Spivack, Sherman Oaks, CA (US); Dominiek ter Heide, Amsterdam (NL)

(73) Assignee: BOTTLENOSE, INC., Sherman Oaks, CA (US)

(21) Appl. No.: 13/752,333

(22) Filed: Jan. 28, 2013

Related U.S. Application Data
(60) Provisional application No. 61/723,280, filed on Nov. 6, 2012.
(60) Provisional application No. 61/591,696, filed on Jan. 27, 2012.

(51) Int. Cl. H04L 29/06

(52) U.S. Cl. CPC H04L 65/403
USPC 715/753

(57) ABSTRACT

A system and a method for trending of aggregated personalized information streams and multi-dimensional graphical depiction thereof are disclosed. The method, which may be embodied on a system, includes retrieving a plurality of social media objects that relates to a focused social media object from social media sites; determining relationships between the social media objects; and/or presenting, at a graphic interface, a network diagram including nodes and lines. In one embodiment, each individual node of the nodes represents one of the social media objects. Each individual line of the lines represents one of the relationships between two of the social media objects that are represented by two of the nodes being connected by the individual line.

### CROSS-REFERENCE TO RELATED APPLICATIONS

This application claims the benefit of U.S. Provisional Application No. 61/591,696 under 35 USC 119(e), entitled “TRENDING OF AGGREGATED PERSONALIZED INFORMATION STREAMS AND MULTI-DIMENSIONAL GRAPHICAL DEPICTION THEREOF,” (Attorney Docket No, 76584-8002.US00), filed on Jan. 27, 2012, the contents of which are incorporated herein by reference. This application also claims the benefit of U.S. Provisional Application No. 61/723,280, entitled “SYSTEMS AND METHOD FOR CONTINUOUS AND REAL-TIME OR NEAR REAL-TIME TARGETING OF SOCIAL NETWORK ADVERTISEMENTS AND OTHER PROMOTIONAL CONTENT,” (Attorney Docket No. 76584-8008.US00), filed on Nov. 16, 2012, the contents of which are incorporated herein by reference.

This application is related to U.S. application Ser. No. 13/752,343, entitled “TARGETED ADVERTISING BASED ON TRENDING OF AGGREGATED PERSONALIZED INFORMATION STREAMS” (Attorney Docket No. 76584-8002.US02), also filed on Jan. 28, 2013, the contents of which are incorporated herein by reference.

This application is related to U.S. patent application Ser. No. 13/403,937, entitled “SYSTEM AND METHOD FOR ANALYZING MESSAGES IN A NETWORK OR ACROSS NETWORKS,’ (Attorney Docket No. 76584-8001.US02), filed on Feb. 23, 2012, the contents of which are incorporated herein by reference.

### BACKGROUND

Through web-based media services like Twitter and Facebook, a user is exposed to a vast amount of messages from hundreds if not thousands of online sources and friends, culminating in massive amounts of information overload. Because the distinctions between each social network are not entirely clear, users feel obligated to juggle different applications and social networks just to keep up and be heard everywhere.

It would be one thing if all our social messages were part of a single, pars able, filtered stream. But instead, they come from all different directions. The situation is aggravated by social streams that originate in many competing silos. Users or consumers spend nearly as much time hopping between networks as we do meaningfully digesting and engaging the content within. Furthermore, the cross-posting across networks further exacerbates the noise and redundancy of the various networks and services.

### BRIEF DESCRIPTION OF THE DRAWINGS

One or more embodiments of the present invention are illustrated by way of example and are not limited by the figures of the accompanying drawings, in which like references indicate similar elements.

FIG. 1 illustrates an example block diagram of a host server of able to analyze messages in a network or across networks including messages to or from various online media services.

FIG. 2A depicts an example block diagram showing the various origins and destinations of messages which can be analyzed by the host server.

FIG. 2B depicts a diagram showing examples of media services whose messages can be analyzed for various applications.

FIG. 3A depicts an example block diagram of a host server able to analyze messages in or across networks for various applications. FIG. 3C depicts an example block diagram of the content targeting engine of FIG. 3A.

FIG. 3B depicts an example block diagram of the user assistance engine in the host server able to perform various customized actions on messages including to personalize and/or filter messages for users.

FIG. 4A illustrates an example entry in a user analytics repository.

FIG. 4B illustrates an example entry in a message analytics repository.

FIG. 4C illustrates a table showing various configuration settings in a semantic rules set.

FIG. 5A depicts an example screenshot showing a multiple-panel interface of an enterprise view.

FIG. 5B depicts an example screenshot showing a multiple-panel interface including an interface for social media account links.

FIG. 5C depicts an example screenshot showing a multiple-panel interface displaying messages of a social media account.

FIG. 5D depicts an example screenshot showing a multiple-panel interface including a main folder.

FIG. 6A depicts an example flow chart illustrating an example process for generating keywords to target advertisements.

FIG. 6B depicts an example flow chart illustrating an example process for directly targeting advertisements to users.

FIG. 7A depicts an example screenshot showing a multi-panel information aggregation interface for displaying the trending of aggregated personalized information streams.

FIG. 7B depicts an example screenshot showing the information aggregation interface with advertisements.

FIG. 7C depicts an example screenshot showing the information aggregation interface after a user clicks an Explore button.

FIG. 8 depicts an example flow chart illustrating an example process for aggregating social media data and presenting a trending of the related social media data.

FIG. 9A depict an example screenshot showing that additional details of a message appear in the right pane when a user clicks the specific message in the stream interface.

FIG. 9B depict an example screenshot showing that a video appears in the right pane when a user clicks a specific message regarding the video in the stream interface.

FIG. 10 shows a diagrammatic representation of a machine in the example form of a computer system within which a set of instructions, for causing the machine to perform any one or more of the methodologies discussed herein, may be executed.

### DETAILED DESCRIPTION

The following description and drawings are illustrative and are not to be construed as limiting. Numerous specific details are described to provide a thorough understanding of the disclosure. However, in certain instances, well-known or conventional details are not described in order to avoid obscuring the description. References to one or an embodiment in the present disclosure can be, but not necessarily are, references to the same embodiment; and, such references mean at least one of the embodiments.

Reference in this specification to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not other embodiments.

The terms used in this specification generally have their ordinary meanings in the art, within the context of the disclosure, and in the specific context where each term is used. Certain terms that are used to describe the disclosure are discussed below, or elsewhere in the specification, to provide additional guidance to the practitioner regarding the description of the disclosure. For convenience, certain terms may be highlighted, for example using italics and/or quotation marks. The use of highlighting has no influence on the scope and meaning of a term; the scope and meaning of a term is the same, in the same context, whether or not it is highlighted. It will be appreciated that the same thing can be said in more than one way.

Consequently, alternative language and synonyms may be used for any one or more of the terms discussed herein, nor is any special significance to be placed upon whether or not a term is elaborated or discussed herein. Synonyms for certain terms are provided. A recital of one or more synonyms does not exclude the use of other synonyms. The use of examples anywhere in this specification including examples of any terms discussed herein is illustrative only, and is not intended to further limit the scope and meaning of the disclosure or of any exemplified term. Likewise, the disclosure is not limited to various embodiments given in this specification.

Without intent to further limit the scope of the disclosure, examples of instruments, apparatus, methods and their related results according to the embodiments of the present disclosure are given below. Note that titles or subtitles may be used in the examples for convenience of a reader, which in no way should limit the scope of the disclosure. Unless otherwise defined, all technical and scientific terms used herein have the same meaning as commonly understood by one of ordinary skill in the art to which this disclosure pertains. In the case of conflict, the present document, including definitions will control.

Embodiments of the present disclosure include systems and methods for trending of aggregated personalized information streams and multi-dimensional graphical depiction thereof.

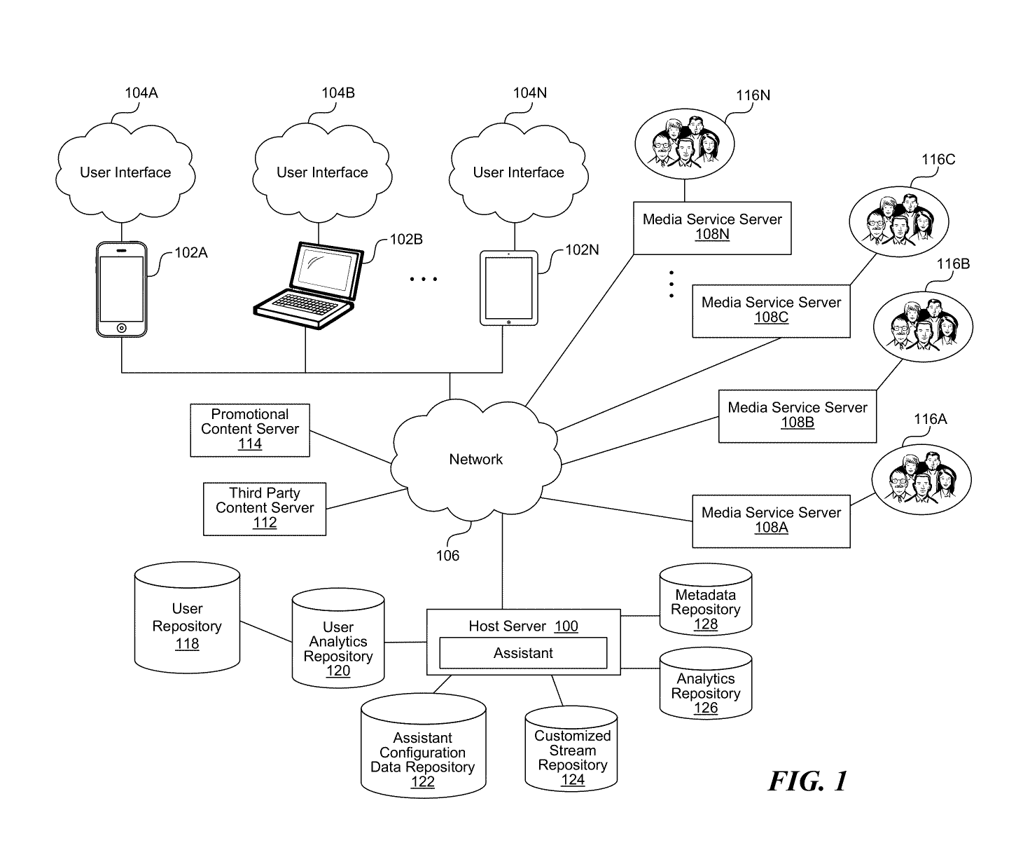

FIG. 1 illustrates an example block diagram of a host server 100 of able to analyze messages in a network 106 or across networks including messages to or from various online media services (hosted by media service servers 108A-N), third party content servers 112, and/or promotional content server 114.

The client devices 102A-N can be any system and/or device, and/or any combination of devices/systems that is able to establish a connection with another device, a server and/or other systems. Client devices 102A-N each typically include a display and/or other output functionalities to present information and data exchanged between among the devices 102A-N and the host server 100.

For example, the client devices 102 can include mobile, hand held or portable devices or non-portable devices and can be any of, but not limited to, a server desktop, a desktop computer, a computer cluster, or portable devices including, a notebook, a laptop computer, a handheld computer, a palmtop computer, a mobile phone, a cell phone, a smart phone, a PDA, a Blackberry device, a Treo, a handheld tablet (e.g. an iPad, a Galaxy, Xoom Tablet, etc.), a tablet PC, a thin-client, a hand held console, a hand held gaming device or console, an iPhone, and/or any other portable, mobile, hand held devices, etc. The input mechanism on client devices 102 can include touch screen keypad (including single touch, multi-touch, gesture sensing in 2D or 3D, etc.), a physical keypad, a mouse, a pointer, a track pad, motion detector (e.g., including 1-axis, 2-axis, 3-axis accelerometer, etc.), a light sensor, capacitance sensor, resistance sensor, temperature sensor, proximity sensor, a piezoelectric device, device orientation detector (e.g., electronic compass, tilt sensor, rotation sensor, gyroscope, accelerometer), or a combination of the above.

The client devices 102A-N, media service servers 108A-N, the respective networks of users 116A-N, a content server 112, and/or promotional content server 114, can be coupled to the network 106 and/or multiple networks. In some embodiments, the devices 102A-N and host server 100 may be directly connected to one another. The media services hosted by the media service servers 108A-N can include any online or web-based media services or networking services whereby a crowd or network of users contribute to the distribution of original or reposted content. These media services include, for example, Twitter, Facebook, Google+, LinkedIn, and any other sites, services, or platforms where users can share information and networks with other users.

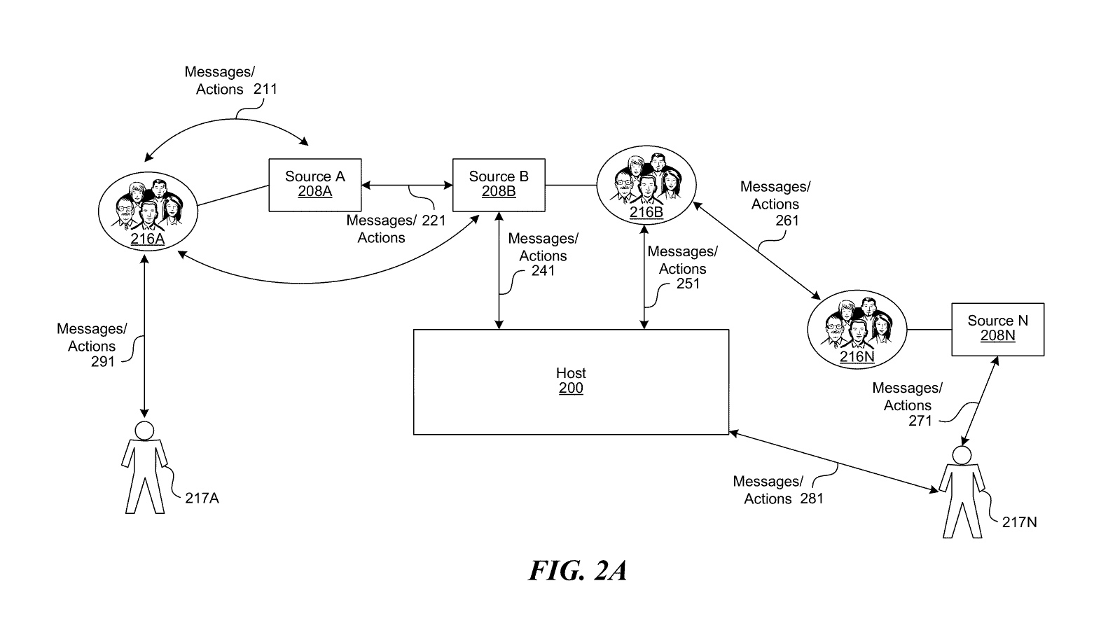

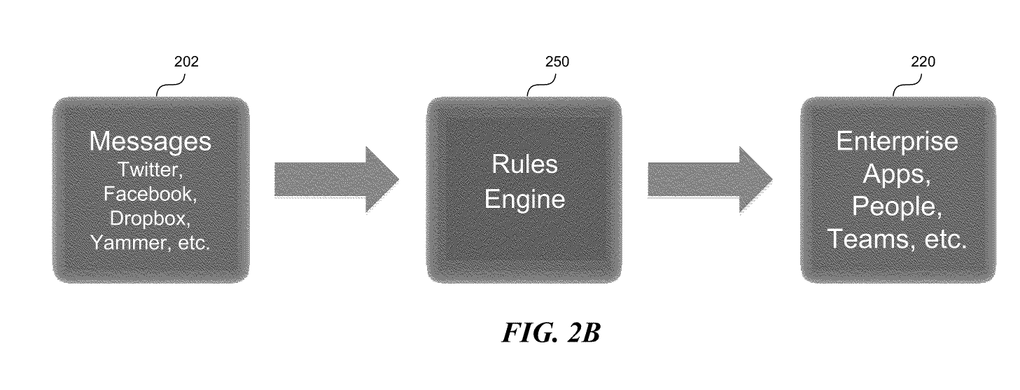

In one embodiment, the host server 100 is operable to analyze streams or sets of messages in a network or across networks to extract statistics to determine useful data such as trends, topics, behaviors, etc. The streams or sets of messages/content can be the target of any online or network-based activity, some of which are illustrated in the example of FIG. 2A. For example, any message or content resulting from or as the basis of activities between users and a network resource (e.g., content provider, networking site, media service provider, online promoter, etc.) can be analyzed for which analytics can be used for various applications including, content/message personalization/customization and filtering, trend/popularity detection (on certain sites (e.g., what's popular on Twitter in the last 2 hours), across all sites or select sets of sites, over a certain time period , in a certain geographical locale (e.g., in the United State), as relating to a certain topic (e.g., what's trending in sports right now), etc.) or a combination of the above. Additional applications include targeted advertising from a user-driven facet, platform-driven facet, timing-facet, delivery-style/presentation-style-facet, advertiser-facet, or any combination of the above.

In general, the host server 100 operates in real-time or near real-time and is able to generate useful analytics/statistics regarding network or online activity to detect current trends or predict upcoming trends for various applications. Delay time analytics and statistics can also be extracted in any specified timing window. In one embodiment, message/content analytics can also be used in generating unique user interfaces and UI features useful for displaying trends or popular topics/types/people/content in an intuitive manner for navigation, as illustrated and will be further described with reference to the screenshots of FIGS. 11-12.

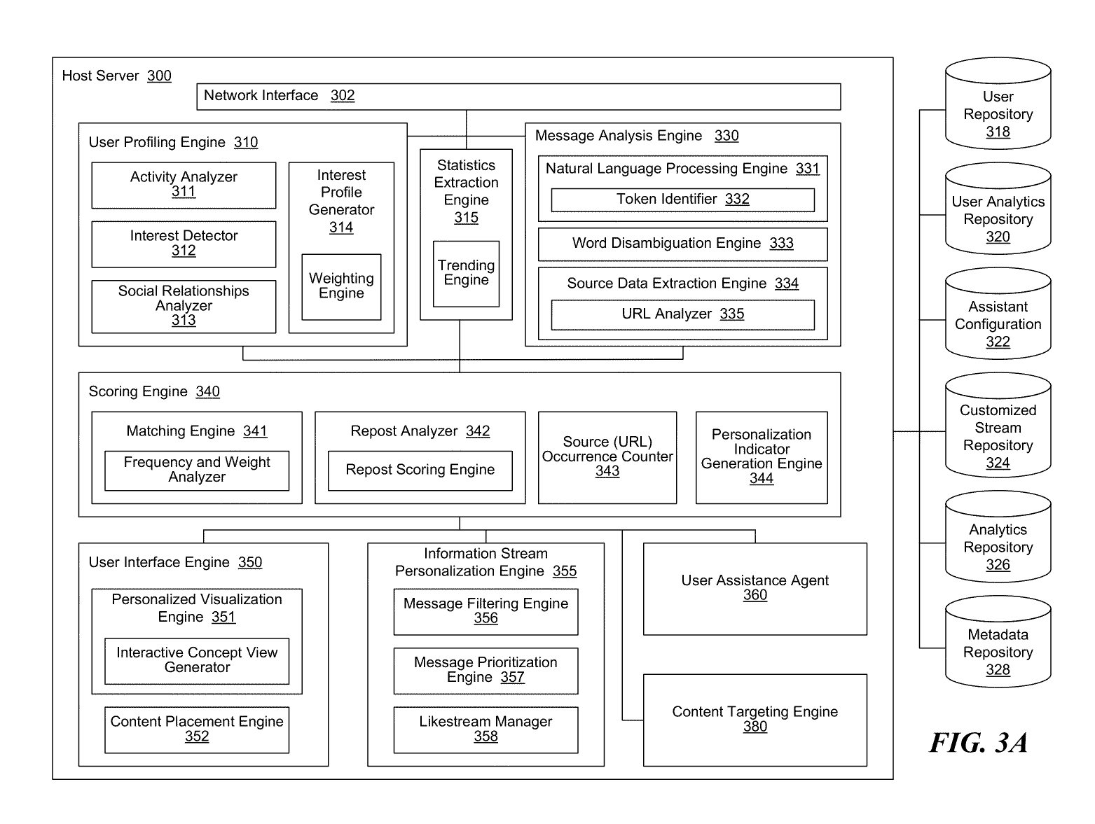

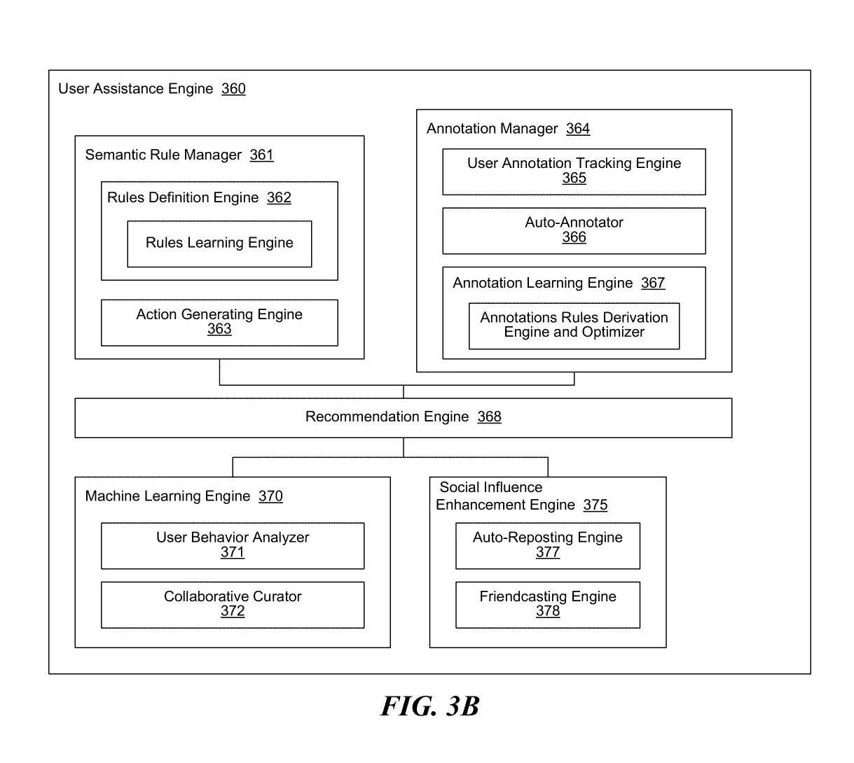

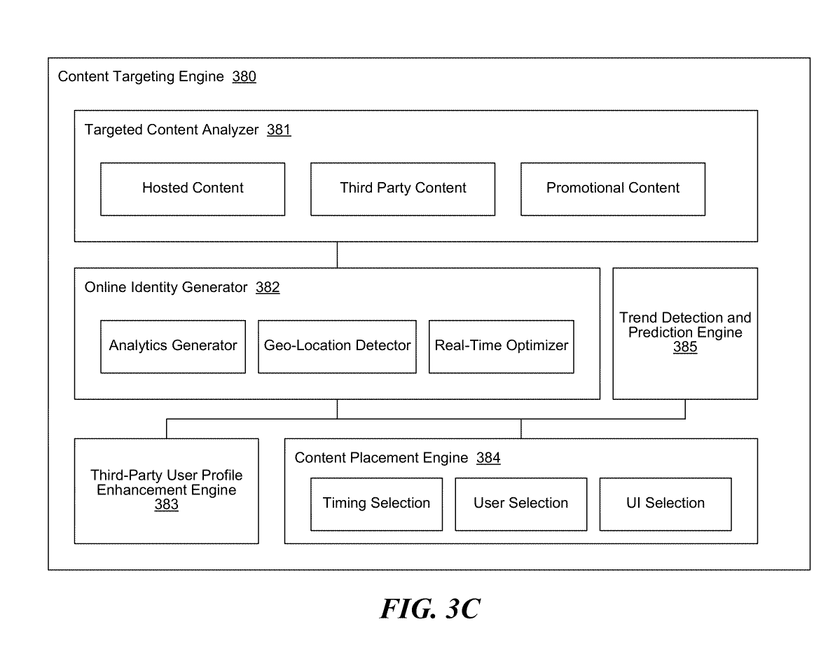

Functions and techniques performed by the host server 100 and the components therein are described in detail with further references to the examples of FIGS. 3A-B.

In general, network 106, over which the client devices 102A-N, the host server 100, and/or various media service servers 108A-N, content server 112, and/or promotional content server 114 communicate, may be a cellular network, a telephonic network, an open network, such as the Internet, or a private network, such as an intranet and/or the extranet, or any combination thereof. For example, the Internet can provide file transfer, remote log in, email, news, RSS, cloud-based services, instant messaging, visual voicemail, push mail, VoIP, and other services through any known or convenient protocol, such as, but is not limited to the TCP/IP protocol, Open System Interconnections (OSI), FTP, UPnP, iSCSI, NSF, ISDN, PDH, RS-232, SDH, SONET, etc.

The network 106 can be any collection of distinct networks operating wholly or partially in conjunction to provide connectivity to the client devices 102 and the host server 100 and may appear as one or more networks to the serviced systems and devices. In one embodiment, communications to and from the client devices 102 can be achieved by an open network, such as the Internet, or a private network, such as an intranet and/or the extranet. In one embodiment, communications can be achieved by a secure communications protocol, such as secure sockets layer (SSL), or transport layer security (TLS).

In addition, communications can be achieved via one or more networks, such as, but are not limited to, one or more of WiMax, a Local Area Network (LAN), Wireless Local Area Network (WLAN), a Personal area network (PAN), a Campus area network (CAN), a Metropolitan area network (MAN), a Wide area network (WAN), a Wireless wide area network (WWAN), enabled with technologies such as, by way of example, Global System for Mobile Communications (GSM), Personal Communications Service (PCS), Digital Advanced Mobile Phone Service (D-Amps), Bluetooth, Wi-Fi, Fixed Wireless Data, 2G, 2.5G, 3G, 4G, IMT-Advanced, pre-4G, 3G LTE, 3GPP LTE, LTE Advanced, mobile WiMax, WiMax 2, WirelessMAN-Advanced networks, enhanced data rates for GSM evolution (EDGE), General packet radio service (GPRS), enhanced GPRS, iBurst, UMTS, HSPDA, HSUPA, HSPA, UMTS-TDD, 1xRTT, EV-DO, messaging protocols such as, TCP/IP, SMS, MMS, extensible messaging and presence protocol (XMPP), real time messaging protocol (RTMP), instant messaging and presence protocol (IMPP), instant messaging, USSD, IRC, or any other wireless data networks or messaging protocols.

The host server 100 may include internally or be externally coupled to a user repository 118, a user analytics repository 120, a configuration data repository 122, a customized stream repository 124, an analytics repository 126 and/or a metadata repository 128. The repositories can store software, descriptive data, images, system information, drivers, and/or any other data item utilized by other components of the host server 100 and/or any other servers for operation. The repositories may be managed by a database management system (DBMS), for example but not limited to, Oracle, DB2, Microsoft Access, Microsoft SQL Server, PostgreSQL, MySQL, FileMaker, etc.

The repositories can be implemented via object-oriented technology and/or via text files, and can be managed by a distributed database management system, an object-oriented database management system (OODBMS) (e.g., ConceptBase, FastDB Main Memory Database Management System, JDOlnstruments, ObjectDB, etc.), an object-relational database management system (ORDBMS) (e.g., Informix, OpenLink Virtuoso, VMDS, etc.), a file system, and/or any other convenient or known database management package.

In some embodiments, the host server 100 is able to provide data to be stored in the user repository 118, the user analytics repository 120, the configuration data repository 122, the customized stream repository 124, the analytics repository 126 and/or the metadata repository 128. The user repository 128 and/or user analytics repository 120 can store user information, user profile information, demographics information, analytics, statistics regarding consumed content and posted content, user influence, usage trends, trending topics, search terms, search trends, user response rates, topics of interest, online activity profile, topics of expertise, social relationships, friends on various networks or online media sites, social statistics (growth in friends, change in influence, level of sentiment or trust about them from others, where they fit in the social graph, who they are related to, who they are similar to), etc.

One embodiment further includes the assistant configuration data repository 122 which can store rule sets which specify actions to be performed on a message based on a detected condition or sets of conditions, for a given user or users meeting certain criteria, etc. The rule sets can be user defined or machine created (e.g., from machine learning user behavior or aggregate user behavior) to customize the way messages and content from various sources are organized and presented to a user or groups of users. The customized stream repository 124 can store streams of messages or content that is personalized or customized to individual users including streams with liked content, filtered content, categorized based on topic, type, content, associated users, people, related sites or sources, and/or prioritized content based on relevance or importance.

One embodiment further includes the analytics repository 126 which can store analytics or statistical data regarding messages, content, websites, searches, media network activity, or any online or network activity surrounding messages, content, people, events, online media sites, social media sites, content providers, any other third party services or online services, etc. The metadata repository 128 stores metadata for online content and messages. The metadata can be machine annotated or user annotated and can include both static and/or dynamic metadata which specifies semantic type or attributes of messages or other content.

Specifically, the metadata can be extracted or attached to messages/content in or across networks 106 by the host server 100. Metadata can also include formatting and display information such as a custom avatar image, background, layout, font choice, stylesheet or CSS attributes. Message metadata can be extended by plug-ins as well, enabling additional layers of metadata and functionality to be added to messages via the host server 100.

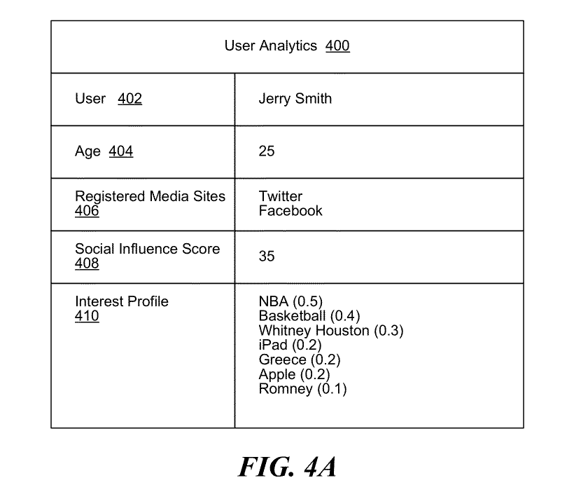

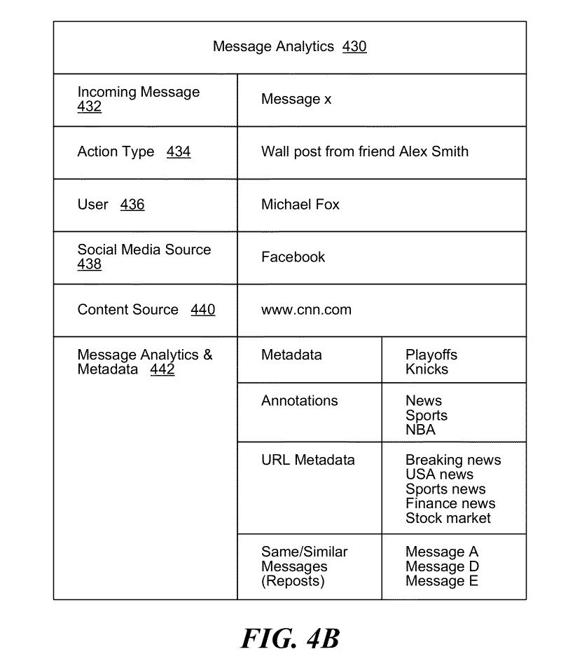

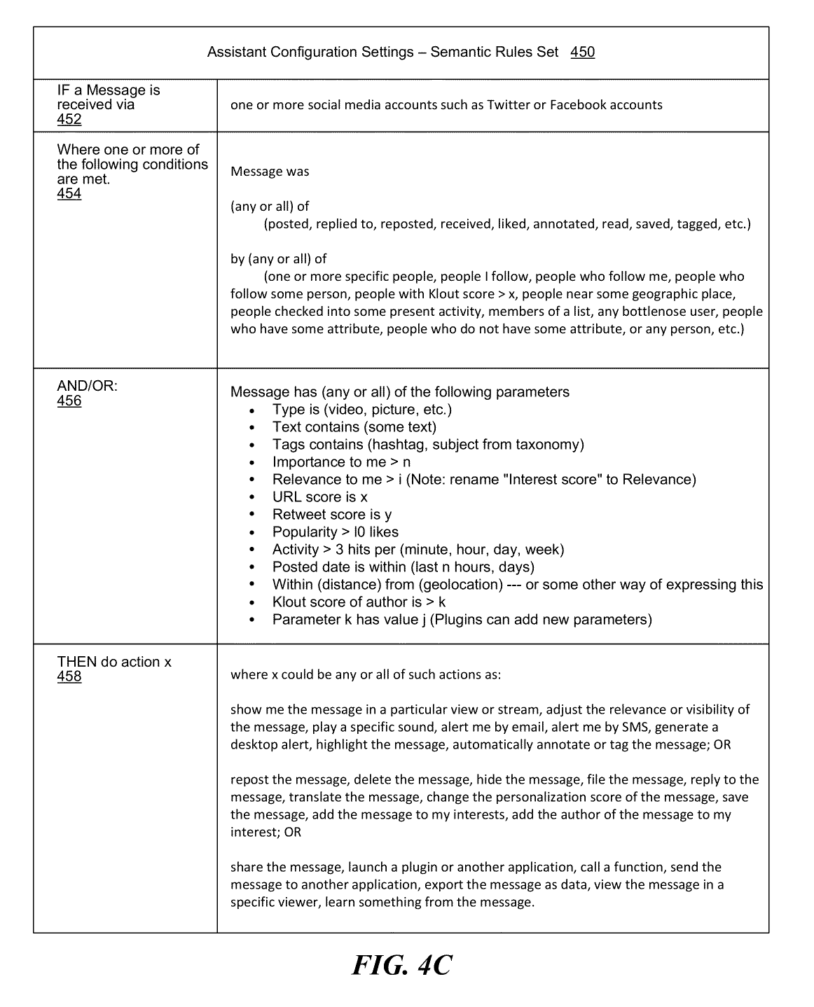

Additional details of examples of types of data stored in repositories are illustrated with further reference to database entries shown in examples of FIG. 4A-FIG. 4C.

FIG. 2A depicts an example block diagram showing the various origins and destinations of messages/actions and/or content that are the subject of online or network activity. Any message/action/content that is the subject of online or network activity which is user-driven or machine-driven can be detected and analyzed by the host server 200 to extract useful information for trending, personalization, customizing, or filtering purposes. The content sources 208A-N and users 216A-N and 217 can be destinations/origins of any message/content or be the originator/recipient on an action performed on a message/content.

Actions can include, by way of example but not limitation, posted, replied to, reposted, received, liked, annotated, read, saved, favorited, bookmarked, viewed, deleted, tagged, commented, tweeted, linked, searched for, etc. Messages and/or content can generally include, messages associated with video content, messages associated audio content, and messages associated photos, any message interacted with by humans or machines, user profiles, user events, user likes or dislikes, status updates, mentions, news, news feeds, current events, breaking news, tweets, messages associated links, notes, web pages, documents, email messages, comments, chat messages/logs, SMS messages, etc.

Messages or content 211 can be sent between a network of users 216A of a content source A 208A (e.g., an online networking site or other content sharing/networking sites) or be the subject of online activity by users 216A of the online site of content source A 208A. The messages and/or content 221 analyzed can also be transmitted between sites (e.g., source A 208A and source B 208B).

The messages and/or content can include messages 291 acted upon between a user 217A and a social network of user 216A, messages 231 between a social network of users 216A and a different online network site (e.g., content source 208A), messages 241 acted upon between the host 200 and a content source (e.g., content source B 208B), messages/content 251 between a network of users 216B (e.g., users of Facebook or Twitter) and host server 200, messages/content 261 acted upon between users of different online networks (e.g., 216B and 216N), or messages/content 271 between any user 217N (e.g., a user who is not necessarily part of a given social network or any social network) and a source N 208N, or content/messages 281 between any user 217N directly to the host 200.

FIG. 2B depicts a diagram showing examples of media services whose messages can be analyzed for various applications. The set of messages/content in question can be analyzed in accordance to set of rules applied by the rules engine. The results of the analysis and statistics can be used in various applications including individual users, for enterprises/companies or organizations, for teams of people or for specific applications, for detecting, identifying trends, filtering/prioritizing according to topics/trends/what's popular, and for generating interactive user interfaces which depict trends or popular topics/ideas/concepts updatable in real time or near real time. The interactive UI may also be actionable to navigate to or through related topics, tags, ideas, people, users, or content.

FIG. 3A depicts an example block diagram of a host server 200 able to analyze messages in or across networks for various applications.

The host server 300 can include, for example, a network interface 302, a user profiling engine 310, a message analysis engine 330, a scoring engine 340, a user interface engine 350, an information stream personalization engine 355, a user assistance agent 360, and/or a content targeting engine 380. Additional or less components/modules/engines can be included in the host server 300 and each illustrated component.

The network interface 201 can be a networking module that enables the host server 200 to mediate data in a network with an entity that is external to the host server 200, through any known and/or convenient communications protocol supported by the host and the external entity. The network interface 201 can include one or more of a network adaptor card, a wireless network interface card (e.g., SMS interface, WiFi interface, interfaces for various generations of mobile communication standards including but not limited to 1G, 2G, 3G, 3.5G, 4G, LTE, etc.,), Bluetooth, a router, an access point, a wireless router, a switch, a multilayer switch, a protocol converter, a gateway, a bridge, bridge router, a hub, a digital media receiver, and/or a repeater.

As used herein, a “module,” a “manager,” an “agent,” a “tracker,” a “handler,” a “detector,” an “interface,” or an “engine” includes a general purpose, dedicated or shared processor and, typically, firmware or software modules that are executed by the processor. Depending upon implementation-specific or other considerations, the module, manager, tracker, agent, handler, or engine can be centralized or its functionality distributed. The module, manager, tracker, agent, handler, or engine can include general or special purpose hardware, firmware, or software embodied in a computer-readable (storage) medium for execution by the processor.

As used herein, a computer-readable medium or computer-readable storage medium is intended to include all mediums that are statutory (e.g., in the United States, under 35 U.S.C. 101), and to specifically exclude all mediums that are non-statutory in nature to the extent that the exclusion is necessary for a claim that includes the computer-readable (storage) medium to be valid. Known statutory computer-readable mediums include hardware (e.g., registers, random access memory (RAM), non-volatile (NV) storage, to name a few), but may or may not be limited to hardware.

One embodiment of the host server 200 includes the user profiling engine 210. The user profiling engine 210 can be any combination of software agents and/or hardware modules (e.g., including processors and/or memory units) able to detect, aggregate, generate, create, predict, retrieve, determine, identity user interests and creating a profile from the user's interests, based from a user's online or network-based activities.

The user profiling engine 210 can, for example, determine the interests of a user without requiring any interaction other than to provide an online identity (e.g. Twitter or Facebook username or other online sites). The user profiling engine 210 can generate an interest profile (e.g., via the interest profile generator 214) with a list of concepts/topics that are of interest to a user. The concepts that are listed may be weighted (e.g., by the weighting engine) in accordance with level of relevance or level of interest to the user. For example, if a user is interested in the company “Microsoft” as detected from his/her feeds, status updates, messages, emails, etc. this word can appear in that profile, and it can be further weighted based on a level of interest as compared to other concepts/topics in the user's interest profile.

The user profile further includes an activity analyzer 211 which detects various user activities online for use in analyzing user behavior to detect/identify user interests in generating the interest profile. The activities that can be detected and analyzed include, by way of example, posted a message, shared a message, liked a message, favorited a message, tagged a message, annotated a message, rated a message, and commented on the message, replied to the message, viewed the message, saved or bookmarked the message.

The activities can also include activities/social relationships relating to other users as detected or analyzed by a social relationships analyzer 213 of the user profiling engine 210. For example, people parameters of people who interacted with a message, people who a user is friends with or connected to, followed people, following people, people who follow specified other people, people with a certain social influence level, geographical parameters of the people, membership or group affiliation, degrees of separation, screen name of an author, author follower count, author following count, author average messages per day.

User interests can be detected by the interest detector 212 by analyzing user content provided in the online activity at or via the online media services, the user content including user-submitted content or user-generated content. The interests of the user can also be determined from other users with whom the user is connected or is friends in the online media services.

The statistics extraction engine 215 reviews the results of the analysis and extracts quantitative information about the user and the associated interests. In one embodiment, the interests of the user are represented by concepts weighted according to analysis of user content which is subject of the online activities at the online media services, an example of which is illustrated in a data entry for user analytics shown in FIG. 4A. Weights can be assigned by the weighting engine based on results of activity and message analysis.

The statistics or any qualitative data computed as a function of time in a given time period or in real time can be used to detect trends (e.g., via the trending engine), potential trends or upcoming trends from any set of messages or online activity. For example, sets of messages relating to a given user can be analyzed to identify trends in the user's interest. Messages/content relating to a given platform can be analyzed to detect what is popular on that site right now. Messages/content relating to a specific topic (e.g., sports) can be analyzed to identify what's currently popular or trending in sports news.

Concepts or topics can be identified from messages by the message analysis engine 230 through natural language processing (e.g., by the natural language processing engine 231). The identified concepts or topics can be used to build a user's interest profile or to determine the related concepts/ideas of a given message, or piece of content to further determine appropriate action. When using message analysis to build an interest profile for a given user, the following steps can be performed:

1) Retrieve messages acted on (e.g., written, liked, commented, etc.) by user X. 2) For each message, detect language tokens (e.g. semi-colons, comma's, whitespaces, others, etc.) and identify social network tokens (e.g., hash tags, @tags, +tags, or other tags, URLs/URIs, usernames, emoticons, micro-syntax, etc.). 3) For each message, assign part-of-speech tags to words using, for example, a dictionary (e.g. noun, adjective, verb, pronoun, unknown). 4) Collect nouns, pronouns and/or unknown words from all messages and take the most frequently occurring N words. 5) Refine/optimize this list of words by omitting common words and written expressions using dictionaries. The resulting interest profile will have a list of words. Each word can be assigned a weighting which is based on how often that word occurred in user X's online activity.

In general, the above analysis process can be applied to any set of messages to retrieve a list of words which can represent the common or frequently occurring topics, themes, concepts, places, people, or things, etc. Such detection can be used to detect, identify, predict, determine trends, upcoming trends, and/or popular topics/themes/concepts from any set of messages. The set of messages can be relating those across multiple platforms/services (e.g., all messages/content/activity on Twitter, Facebook and LinkedIn in the last 10 hours), across a given platform/service (e.g., all activity on Twitter in the last 2 hours), across one or more platforms/services in a given geographical local (e.g., all activity on Twitter, Facebook in San Francisco), across one or more platforms/services for a given user, or a specific group of users, across one or more platform/services as pertaining to a specific topic (e.g., US Open, NBA, etc.), or any combination of the above parameters.

For example, a user can choose to detect trends in activities for people or a group of users that he follows on Twitter, or to access trends from last week. Changes in trends can also be determined, the strength of a given trend (e.g., how rapidly some topic/concept is becoming popular) can also be computed by performing quantitative analysis on messages/content and other activities occurring across a single network or multiple networks and any number of social media platforms.

In one embodiment, the concepts that are detected can be filtered/optimized from messages/content through disambiguation of a given keyword having multiple meanings (e.g. via the word disambiguation engine 333). For example, the word “Java” has multiple meanings/contexts including, for example, Java, the island in Indonesia, is it Java, the programming language. In this instance, disambiguation processes can be performed to determine which meaning of the word is applicable.

In some instances, disambiguation can be performed by analyzing the surrounding words in the sentence that the word occurred in. In this example, the surrounding sentence could be “I'm traveling to Java next week.” VS “I was programming Java all day,” which allows a system to decide the correct definition of the word.

In one embodiment, when the user profiling engine 310 builds an interest profile for the user, all words that are found are generally of interest to a user. So for this collection of words, the word disambiguation engine 333 can use the user, or the rest of the messages, as a context to disambiguate the meaning of the words. For example, in one embodiment, a large dictionary of known words and related categories can be locally stored, externally accessed/queried. For example, the dictionary can be synthesized by combining an encyclopedia's (e.g., Wikipedia or other databases) list of topics with the categories those topics belong to.

For messages/content pertaining to a user X, or for any given set of messages, there are a list of words P that need to be disambiguated. For each word in this list, all possible meanings can be retrieved. In this example, this would be “Java (programming language)”, “Java” (the island). In one embodiment, for each meaning of each word, a list of all related categories can be determined and stored. In our example this would be “Programming, Computing, Programming Languages, etc.” and “Indonesia, Asia, Country, Geography”.

For the words in P, it can then be determined those categories that are most frequently occurring. This can be performed by counting and tracking the occurrences of each category across the words in list P. In one embodiment, the amount of category occurrences can then be used to assign a score to each meaning of each word. In this example, if “Programming” occurred multiple times, the meaning “Java (programming language)” will get a higher score. Therefore making this the most correct meaning of the word Java in a set of messages pertaining to user X, or any given set of messages.

In addition, in one embodiment, message analysis includes using information about the message source to detect and retrieve relevant information. For example, additional information about messages can be determined by retrieving and analyzing data for relevant URLs which host the message or content. In one embodiment, each URL or other types of content sources for a set of messages can be analyzed to retrieve and store the information. In addition, browser extension (e.g., bookmarklets) can be used to facilitate this.

For example, browser extensions can be provided to the users to share pages that they like when browsing the interne. In the background however, (without bothering the user), this extension can analyze the page, extract relevant meta-data (e.g. title, description, author, popularity, type, fields, media, etc.). The extracted information about the content source (e.g., URI or URL) can be sent to the host 300 and stored in a repository (e.g., the metadata repository 328).

The scoring engine 340 can determine the relevance of any message/piece of content to a given concept/theme/trend/topic/person/place, etc. The computed relevance of content/message to a concept can be used for various applications including, placement of the content/message (site, person, timing, etc.), retrieval of the content/message when relevant (e.g., when a search is conducted for the topic or a related topic, when a related topic is queried or selected, when the topic itself if queried or selected), placement of promotional content, relevance to a group of users, personalization of message streams for users through filtering and prioritization, etc.

In one embodiment, the scoring engine 240 can generate a score by matching message content against an interest profile or one or more concepts/topics/themes. The interest profile may be for a specific user or for a specific group of users, or just for any given context. The matching can be performed by the matching engine 241 by performing natural language processing to extract relevant concepts from the message or other content. These relevant concepts are then assigned a score by the scoring engine 340 based on, for example, the frequency with which a word occurs in a given interest profile (e.g., by the frequency and weight analyzer) and any associated weighting of the occurred word inside the interest profile (how interesting is that to the user or the query being made which is represented by the interest profile). In some instances, more than two occurrences or more can progressively increase the score.

In one embodiment, the scoring engine 340 modifies or determines the relevancy score based on any reposts (e.g., via the repost analyzer 342). For example, the repost analyzer 342 can compute or otherwise determine the number of times a given post or message occurred in other messages coming from connections or friends relevant to a given context (e.g., people in a certain user group, people with certain interest, people connected/friends with a given user, etc.). In order to compute the score based on reposts, the number of similar messages can be determined. However, in general, when users repost a message, they often modify the original message to make it fit within a certain character limit. Therefore simply finding messages with the same text might yield poor results since exact messages will only be found in limited numbers.

As such, for a reposted message R, a search needs to be done across all stored messages M. If there is a match, the Repost Score can be incremented and a similarity link can be stored by the repost scoring engine. In one embodiment, this can be performed by retrieving all stored messages M and compare each M to R and identifying the M that had the most words in the sentence that matched. In another embodiment, a database full-text ‘OR search’ can be performed with all words in the sentence of R. Then, rank the results according to the number of keywords that matched and select the top matching results as similar messages.

In one embodiment, for a reposted message R, a natural language processing tool can be used to extract words, keywords, symbols, and/or tokens for that message. The words/keywords can include, but are not limited to: Nouns, Proper Nouns and Adjectives; the tokens include, but are not limited to: URLs, hashtags, user names, emoticons or other symbols. The repost analyzer 342 can then sorted and packed the tokens and/or keywords/words together into a repost index RI which can be generated for each message in M. The Repost Score can now be determined by performing a single database lookup on RI in M. Such a query is resource and time efficient since it is an exact match on a database field that can be indexed a second time via database queries.

In some instances, content source occurrence frequency can also be factored in (e.g., determined by the source occurrence counter 343) to compute the score. For example, one message/piece of content may be more relevant if it is also from a source (e.g., as identified by a URL/URI) with some determined prior relevance to a context (e.g., a specific set of users, a topic, etc.). The score can be increased if the source is frequently occurring. The source occurrence counter 343 can compute how many times the URL in a message occurred in messages relevant to a given context (e.g., from friends or connections of a given user or people that the user is following, etc.).

One application of concept/idea/theme detection and trend identification is personalization of a message stream for a user. In one embodiment, personalized message streams can be created by filtering/prioritizing various messages for the user by the information stream personalization engine 355. The personalization engine 355 can use a score generated by the scoring engine 340 to determine relevance to a user, interest to a given user, based on any specified criteria (e.g., within sports news, tech news, within the last week, etc.). Based on the score with respect to any facet or context, the messages can be filtered by the filtering engine 356 and prioritized by the engine 357 such that a personalized/customized stream of messages can be created and presented to a user.

In one embodiment, one example of a personalized/customized stream of messages for a user is a “likestream,” or a stream of messages/content that the user likes or might like, determined by explicit preferences or implicit preferences. For example, the host server 200 can provide a mechanism by which users may explicitly or implicitly “like” particular messages or people. By “liking” something a user explicitly tells the application that it is of interest. The host 300 (e.g., the personalization engine 355) then assembles a directory of the things the user likes. Within this directory, each faceted view, can be referred to as a “likestream” of things (e.g., messages, audio content, video content or any other content) that are liked by some set of users (such as a single user or even a community or group, such as people within an organization).

For each user x, a faceted directory hierarchy can be generated dynamically that contains all their implicitly or explicitly liked messages and/or people. This directory includes sub-directories, each itself a likestream, for various semantic types of messages liked by user x. For example, a typical likestream directory can include, one or more of:
All liked items by user x;
Videos liked by user x;
Audio liked by user x;
News liked by user x;
Products liked by user x;
Services liked by user x;
Applications liked by user x;
Photos liked by user x;
Quotations liked by user x;
Opinions liked by user x;
People liked by user x;
Ideas/concepts liked by user x;
<other type> liked by user x.

Implicitly liked messages for user x may include any/all messages that user x has authored, replied to, reposted, saved, or shared. User x may also explicitly liked messages or people by taking an action to “like” them in the application. In one embodiment, rating scales for likes can be provided such that users can indicate the degree to which they dislike or like an item.

In one embodiment, Likestreams can be subscribed to by other users who are subscribers of the host service 300 or users of other platforms (e.g., users of other social media networks). For example, when user x views the likestream for user y it is possible for them to subscribe to it as a stream or interest. By subscribing to a likestream, it appears as a stream (with a corresponding editable rule definition) in user x's main dashboard, alongside other streams they can track (generated by other rule definitions). User x may opt to subscribe to user y's top-level root likestream or they can navigate directory facets to reach sub-level likestreams that match a specific patterns (for example, a likestream of only the videos, or only the news articles, that user y likes).

In one embodiment, Likestreams enable users to follow facets of people they are interested instead of everything those people post. This enables users to filter their message streams for only the kinds of messages they want from various people. When adding a likestream for another user y, user x automatically follows user y so that they can get their messages, although in a variation of this feature it is also possible to subscribe to a likestream without following the originator of the likestream.

In addition, Likestreams can also be browsed and searched, both by their owners and by anyone with permission to view them, and in such capacity they provide a means to aggregate and discover knowledge. Messages may have specific permissions associated with them which govern which users may take which actions on the message including, for example:
Read
Write
Edit
Delete
Share
Annotate
Change permissions
Rank, score, prioritize

In one embodiment, likestreams can also be generated for sets of people, such as groups, lists, or communities of people. For example, a likestream, or any customized/personalized stream of messages could be generated for the set of all people a user follows, or just for all people tagged as “friends” or “family.” A likestream can also be generated for all people who share specific attributes such as interests, relevance to specific topics, geolocations, or affiliations. In one embodiment, a likestream can also be generated for all members of the hosted service 300, or for all members of any social network. In general, likestreams can display messages chronologically and/or ranked by the degree to which they are liked and/or the number of people who like them.

The user interface engine 350 can customize the presentation of messages or content based on a given context with may be user or administrator specified. For example, the user interface can present topics or trend relating to ‘tech news’ or ‘elections.’ The user interface can also be configured to present messages/content in a personalized manner based on implicit and/or explicit user interests and/or preferences. In one embodiment, the visualization engine 351 creates a graphical visualization of concepts or topics contained in the messages/content based on a given facet (e.g., the context may be topic/concept driven, user driven, location driven, platform driven, or based on any other facet), with each concept or topic is represented by a label which is arranged radially from a node (e.g., as generated by the interactive concept view generator). Around this facet (represented by the common node), there are connected topics, keywords and tags all of which are relevant to that facet in a certain configurable/specifiable timeframe (minutes, days, weeks).

The graphical visualization can be interactive, where, responsive to detection of selection or activation of the label, information related to the represented concept or topic can be further depicted in the graphical visualization. The user interface engine 350 can also update the graphical visualization continuously or periodically (e.g., in real time or near real time) such that the depicted trends/popularity or relevance levels to various facets/users are current. The graphical visualization can also be manipulated to plot and depict past trends at or around a certain time or within a past time period. In general, each node has a different visual style (color, edge thickness, etc.) which is based on how interesting and relevant the node is to a facet or a user (when creating a personalized graph of concepts for a user). When clicking a node, it will show related topics, tags and keywords and it will display related messages/content in a new window or side panel, as illustrated in the example screenshots of FIGS. 11-13.

In one embodiment, the host server 300 can provide mechanisms to reward users for certain social media behaviors and achievements.

Rewards can be provided in many forms—virtual currency such as points for use in the services hosted by server 300, Facebook credits, etc., coupons or gift cards, physical goods and services, or physical currency, or in the form of digital achievement badges, or increases in a user's status, visibility, influence or relevance to others in the hosted network and/or any other networks.

Rewards can be provided for achievements such as:
Getting n followers
Recruiting n new users to bottlenose
Sending n messages
Liking n messages
Annotating n messages
Getting n likes on a message from others
Getting n likes in total from others
Getting n likes on their user profiles from others
Getting n replies on a message
Making n replies to other users
Getting n reposts on a message
Getting n views on a message
Getting n clicks on a URL in a message
Getting n views on their profile page
Getting n followers for a particular likestream of theirs
Achieving an expertise rank of n on a topic or interest
Achieving influence rank of n
Detecting and reporting spam or abuse
Rating content or users of the system
Adding plug-in to the system
Getting n downloads of a plug-in they added

Getting n likes on a plug-in they added

In addition to gaining points, users may also lose points if they do things that are considered unwanted or harmful to the system, such as:
Adding content that is rated as spam or abuse by other members
Miscategorizing content when annotating it

The host server 300 represents any one or a portion of the functions described for the modules. The host server 200 can include additional or less modules. More or less functions can be included, in whole or in part, without deviating from the novel art of the disclosure. The repositories 318, 320, 322, 324, 326 and 328 were discussed in conjunction with the description of FIG. 1.

FIG. 3B depicts an example block diagram of the user assistance engine 360 in the host server able to perform various customized actions on messages including actions to personalize and/or filter messages for users.

The user assistance engine 360 can further include a semantic rule manager 361, an annotation manager 364, a recommendation engine 368, a machine learning engine 370, a social influence enhancement engine 375 and/or a subscription manager.

Additional or less components can be included in the host server 200 and each illustrated component.

As used herein, a “module,” a “manager,” an “agent,” a “tracker,” a “handler,” a “detector,” an “interface,” or an “engine” includes a general purpose, dedicated or shared processor and, typically, firmware or software modules that are executed by the processor. Depending upon implementation-specific or other considerations, the module, manager, tracker, agent, handler, or engine can be centralized or its functionality distributed. The module, manager, tracker, agent, handler, or engine can include general or special purpose hardware, firmware, or software embodied in a computer-readable (storage) medium for execution by the processor.

As used herein, a computer-readable medium or computer-readable storage medium is intended to include all mediums that are statutory (e.g., in the United States, under 35 U.S.C. 101), and to specifically exclude all mediums that are non-statutory in nature to the extent that the exclusion is necessary for a claim that includes the computer-readable (storage) medium to be valid. Known statutory computer-readable mediums include hardware (e.g., registers, random access memory (RAM), non-volatile (NV) storage, to name a few), but may or may not be limited to hardware.

The semantic rule manager 361 provides a rules interface, and engine, to manage, create, implement, revise, and/or optimize the rules which facilitate customized, application-specific, user-specific, use-specific manipulation, processing, retrieval, filtering, prioritizing of messages and any content in a given network, across networks, or across any number of different online media sites or platforms. The rules can be defined by a user, by a platform, a media site, the host server 300, a platform partnering with the host 300, an organization or any other consumer or business entity. In one embodiment, the rule set is specified by the user or other types of entities, via a user interface provided by the service which is independent of the online or web based media services. Based on the set of rules, the manager 361 can cause the server 300 to perform an action on an incoming message in accordance with a rule set to process the incoming messages. One example of an action is the likestream comprised of messages implicitly or explicitly liked by the user as defined by the rule set described in the example of FIG. 3A.

The rules managed and tracked by the manager 361 can be defined to perform actions on messages/content based on one or more specified criteria. The rules can be defined or specified by the rules definition engine 362 and can include application actions such as annotating a message, reposting a message, notifying a user, making a recommendation to a user, launching another application, presenting with increased or decreased visibility or taking some other action. In some instances, the rules are automatically determined by default or automatically created by observing and learning system or user behavior (e.g., by the rules learning engine), as will be further described with reference to the machine learning engine 370.

The criteria can also be specified, defined, tracked or updated/revised by the rules definition engine 362 and can include, by way of example not limitation, if messages is received/acted upon via one or more of the following services, and/or message was (any or all) of (posted, replied to, reposted, received, liked, annotated, read, saved, tagged, etc.) by (any or all) of (one or more specific people, people I follow, people who follow me, people who follow some person, people with Klout score >x, people near some geographic place, people checked into some present activity, members of a list, any bottlenose user, people who have some attribute, people who do not have some attribute, or any person, etc. In general, the rules and criteria may take many features of messages, actions, and relationships, and any combination of the above into account.

The rule sets can be created and applied to create robots or assistance which can identify and customize message/content streams for any application, setting, context, or facet. An example table showing example rules sets to configure these assistants is illustrated in the example of FIG. 4C.

One feature of the host server 300 is the ability to support machine learning, creation, generation of rules of the ma chine learning engine 370 from observing, tracking, identifying, detecting, revising, and updating explicit and/or implicit user preferences/feedback from user specifications and/or behavior (e.g., by the user behavior analyzer).

Many learning rules are possible within the application framework, including by way of example but not limitation:
By analyzing user annotations, the machine learning engine 370 or the annotation learning engine 367 can infer and optimize rules that learn to automate user annotations in the future, and that learn to repost messages on behalf of a user.
Rules relating to people by adding people to a given user's interests or as being relevant to any given facet: The user behavior engine 371 can for instance, determine how much a user X interacts with user Y—for example by measuring how often they interact in one or both directions via replies, mentions, direct private messages, and reposts, or how often they “like” messages by one another, or click on links in messages that are posted by one another. When user X is measured to interact with user Y above a quantitative or qualitative threshold, recommend that user X adds user Y as an interest (interest stream and/or relationship), or automatically add user Y as an interest (which may be a function of yet a higher threshold or the same threshold).
Rules relating to site or content by adding sites to a user's interests or as being relevant to any given facet: The user behavior analyzer 371 can detect sites that a user X cites a lot in their outgoing messages, reposts, mentions, replies, or “likes,” can automatically become interests, or can be recommended to be added as interests for user. Once added as an interest, any messages that are received that cite URLs in sites of interest may then have a higher personalization score for user X or any other specified context/facet automatically.
Add a message to as an interest (via explicit learning) to a user or relevant to a facet: For a given message, a user can add it to their interests manually—they can specify what they want to add (the author, the content, particular topics, everything). The machine learning engine 370 can add the person who made the message automatically (even if the user doesn't follow them yet), as well as relevant keywords or patterns in the message such as the URL and tags etc. By adding to their interests in this manner, the engine 370 learns they are interested in this pattern such that future messages which are received and match the interest will receive a higher personalization score for the user. Similar process can be performed for facets/applications other than specific users, to identify relevant content based on key words, patterns or other criteria.
Ignore messages: The machine learning engine 370 can learn to automatically filter out or ignore messages that match certain patterns such that spam, offensive content, or all content from a specific party can be screened out for a user or for any specific application/context/facet.
Boost messages: The machine learning engine 370 can also learn to automatically boost the visibility or personalization score of messages that are more likely to be relevant to a user or any other given facet/context. In the case of a user, if a user X likes a lot of messages by some author Y, then the engine 370 can learn to make all messages by that author Y more important for user X. Similarly, the engine 370 can learn to boost the personalization score of messages that match various other patterns such as having specific attributes or being relevant to specific interests.

In addition, through the host server 300, anyone can mark any message as having any semantic type or attributes. This may eventually result in some percentage of miscategorized messages. The server 300 may be configured to leverage collaborative filtering in order to curate messages, and detect and filter out errors (e.g., via the collaborative curator 372 of the machine learning engine 370).

One example method for collaborative filtering is as follows:

1. When user a marks item P as type x, then it shows up as type x for that user only no matter what (even if other people disagree).

2. Types added to item by the item's author are innocent until proven guilty: They automatically show up for the crowd until and unless >n non-authors of item subsequently disagree by unmarking type x from item. If the item is unmarked by the crowd, then x doesn't show up on item for anyone other than author anymore. In other words, the author's types show up for everyone, but are removed for everyone other than the author, if enough people disagree.

3. Types added to item by non-authors of item are guilty-until-proven innocent. If >m non-authors of item mark item as type x, then x shows up for everyone. In other words, there must be some agreement before an item will show up as type x, for people other than the person who marks it as x. One exception is of course if the author marks the item as x—in which case see (2).

4. The variables n and m (the thresholds for “disagreement” and “agreement”) can be changed dynamically to adjust the curation thresholds.

Another aspect of machine learning or learning from the user crowd is leveraging message annotations by users (e.g., via the annotation manager 364). For example, if a user shares a message with a URL to the YouTube website, the server 300 can, based on various analysis techniques determine that the message is associated with a video. In some instances, the user can be queried to assist in determining what a message relates to. For example, the host server 300 (e.g., via the annotation manager 364) can query a user when it is posting a new message, reposting an existing message, liking an existing message, or otherwise acting on some message or content.

Once the message has one or more types associated with it (as tracked by the annotation tracking engine 365), the server 300 now has the ability to better provide better filtering of that message or related/similar messages/content all other users. For example if user A and user B have a filter specified for receiving messages that are marked as “News”, there could be a message M that has no type associated with it. When user A likes the message and assigns the type “News” to it, then the message will be filtered as “News” for both user A and user B.

In addition to enabling manual annotation of messages/content by users, rules can be generated which are capable of automatically annotating messages (e.g., by the auto-annotator 366) with metadata when the messages match specific patterns—such as originating from specific URLs or URL fragments, containing specific keywords, being posted or authored by specific parties, containing specific strings.

In addition, by analyzing sets of manually annotated messages, new annotation rules can be automatically derived and optimized over time (e.g., by the annotation learning engine 367), that generalize from collective annotation behavior. For example, if a community of users consistently annotate messages containing pattern x as being of semantic type y, then a rule can learn to make such an annotation automatically when a high enough degree of evidence is accumulated to have sufficient confidence in what has been learned.

In one embodiment, the host server 300 includes the ability to recommend online actions (e.g., including identification of online messages/content) that facilitates enhancement of social influence by a user or any other entity (e.g., business entity, organization, application, idea, concept, or theme). In one embodiment, the host server 300 through the social influence enhancement engine 375 can add an additional indicator (e.g., an influence weight indicator) to detected, tracked, stored, and/or analyzed messages/content. This weighting or indicator resulting in an overview identifying messages/content that can be reposted by the user (or some other physical entity such as a corporation or physical entity representing some ideology) to gain more network influence. The social influence enhancement engine 375 can also recommend certain actions in addition to posting/reposting messages (e.g., liking posts, friending certain people or entities, commenting on certain messages/content) which can also result in enhancement of social influence of a user or entity.

In one embodiment, the engine 375 computes the weighting by looking at the strength of a friend connection and the number of friends of that friend. Also, more sophisticated influence information is gathered by integrating with influence metric services like Klout.com. By measuring the relevance of a message to the interests of a user's followers an algorithm can determine whether the message should be reposted. By measuring historical diffusion of similar messages in a social network, the algorithm may estimate to what degree a particular message might spread further, via a person's followers, and may also recommend what times of day it should be posted in order to attain the maximum attention and spread.

In one embodiment, the server 300 provides auto-reposting capabilities for messages/content (e.g., via the auto-reposting engine 377) based on conditions or criteria that is user configured, auto-configured, or determined by any other third party services/interests.

For example, the auto-reposting engine 377 can provide a variation of Auto-RP in where certain messages are recommended for repost. The user or some other entity can then decide to repost the message or dismiss it. The criteria for auto-reposting or recommending a message/piece of content for repost, or for recommending that some other action be performed, can be based on multiple scores. These can include by way of example but not limitation:
Repost Score (see above)
URL Score (see above)
Frequency of interactions with the user that posted the message
An automatically learned weighting of previous interactions with similar messages
Explicitly user defined matches
The level of influence (such as Klout score) of the author of the message
The strength of relationship between the user and the author of the message (determined for example by the number of times the user has reposted, direct messaged, mentioned, or replied to the author, and/or the number of times the author has reposted, direct messaged, mentioned, or replied to the user.
The number of people who the user follows, who also follow the author of the message—a measure of similarity between the user's interests and the interests of the author.
The degree to which followers of the user may be interested in the author's message, determined for example by measuring the relevance of the message to each of the user's followers.

Formulas that include the above criteria and/or others, can generate a cumulative score for the message/content, or some other related action with respect to a network activity on a media site. A threshold may be defined such that if the score crosses the threshold, then a recommendation to repost a message is made. Users may opt to configure the auto-repost engine 377 to repost qualifying messages automatically, or to simply recommend them so that they can choose to repost them manually.

In one embodiment, the auto-reposting engine 377 can learn reposting rules for specific users or entities or other contexts, for example, by analyzing which messages they have reposted in the past in order to develop statistical models and/or pattern rules that can infer when to repost a new message. For example, if a user x has often reposted messages by another user y in the past, then the probability weight that they should repost any new message by user y in the future is increased. Similarly, by analyzing the features of such messages, the times of day, and the social relationships between user x and y, the precision of such rules can be adjusted and further optimized.

One embodiment of the host server 300 further includes a friend casting engine 378 which provides a default ‘Friendcasting Assistant’. This assistant allows a user x to specify rules that will automatically repost a message from another user under certain conditions. For example, a user x can define that all messages that match a pattern y (such as having a certain hashtag like, ‘#cast’, @tag, +tag, and/or containing certain keywords or strings or URLs, and/or originating from a user u that matches whitelist W) will be automatically reposted by user x. This enables people to request that their friends repost particular messages by simply attaching the appropriate hash tag (such as #cast) or @tag, or other tags to their messages, instead of having to make a direct request for a repost via a message to each person.

The recommendation engine 368 can, using the output of the annotation manger 264, the machine learning engine 370, and/or the influence enhancement engine 375 and make the appropriate recommendations to a user, entity, or any other party or representative accessing the services/features of the host server 300. The recommendations can include rule/action sets defining assistants which are use, application, context, and/or user specific, recommended or suggested annotations based on observation of system and/or user actions/behaviors, recommendations of actions including posts/comments/reposts of content/messages which may enhance social influence of a user or any entity/party/representative, concept, theme, organization.

FIG. 4A illustrates an example entry 400 in a user analytics repository. An example entry 400 can include a user identifier 402 (user name, real name, logon name), demographic information including age 404 and/or other information, an identification of registered media sites 406, influence score of the user 408, for example. The entry can also include the interest profile 410 of the user represented by a list of topics/concepts which can include ideas, products, services, people, sites, or any other entities. In one embodiment, the list of topics/concepts can be weighted to indicate relative level of interest of the user in each of the represented topics/concepts.

FIG. 4B illustrates an example entry 430 in a message analytics repository. The example entry 430 can include, an identification of the message 432, the action type 434 relating to the message, the user who acted on the message 436, an identification of the media platform 438 through which the action was generated, an original content source 440, and/or the analytics 442 associated with the message 432. The analytics can include, for example, metadata, annotations, URL metadata (metadata from cnn.com), and/or an identification of similar messages with may represent reposts. The analytics can be derived or generated by the host system shown in the example of FIGS. 3A-3B. The analytics can also be derived or generated by hosted components residing on the client side, or in any part contributed by end users, consumers, or other third party entities.

FIG. 4C illustrates a table 450 showing various configuration settings in a semantic rules set.

The semantic rule set can be specified to configure assistants to customize media content/messages or activities from one or more media sources (e.g., social media sites or platforms) to be optimally presented for various applications. For example, one assistant can be configured to aggregate and show all posts across multiple media sites by a popular figure (e.g., Mitt Romney), one assistance can be configured to show all posts on Twitter relating to an entity (e.g., the Boston Celtics, or the World Trade Center site) in a given time frame, assistants can also be configured to filter and show content relating to certain users or posted/acted on by certain users (e.g., select users who are members of a group or certain select users that specified according to some other criteria).

Multiple assistants can be created from different rule sets such that multiple content or message streams are generated for different applications. Each rule set can implement one or a combination of conditions (e.g., as shown in sets 452, 454 an 465), and when the condition(s) are met, any number of the actions x 458 can be performed.

The action x can include, for example, any number of such actions as: show me the message in a particular view or stream, adjust the relevance or visibility of the message, play a specific sound, alert me by email, alert me by SMS, generate a desktop alert, highlight the message, automatically annotate or tag the message, repost the message, delete the message, hide the message, file the message, reply to the message, translate the message, change the personalization score of the message, save the message, add the message to my interests, add the author of the message to my interests, share the message, launch a plug-in or another application, call a function, send the message to another application, export the message as data, view the message in a specific viewer, learn something from the message, etc.

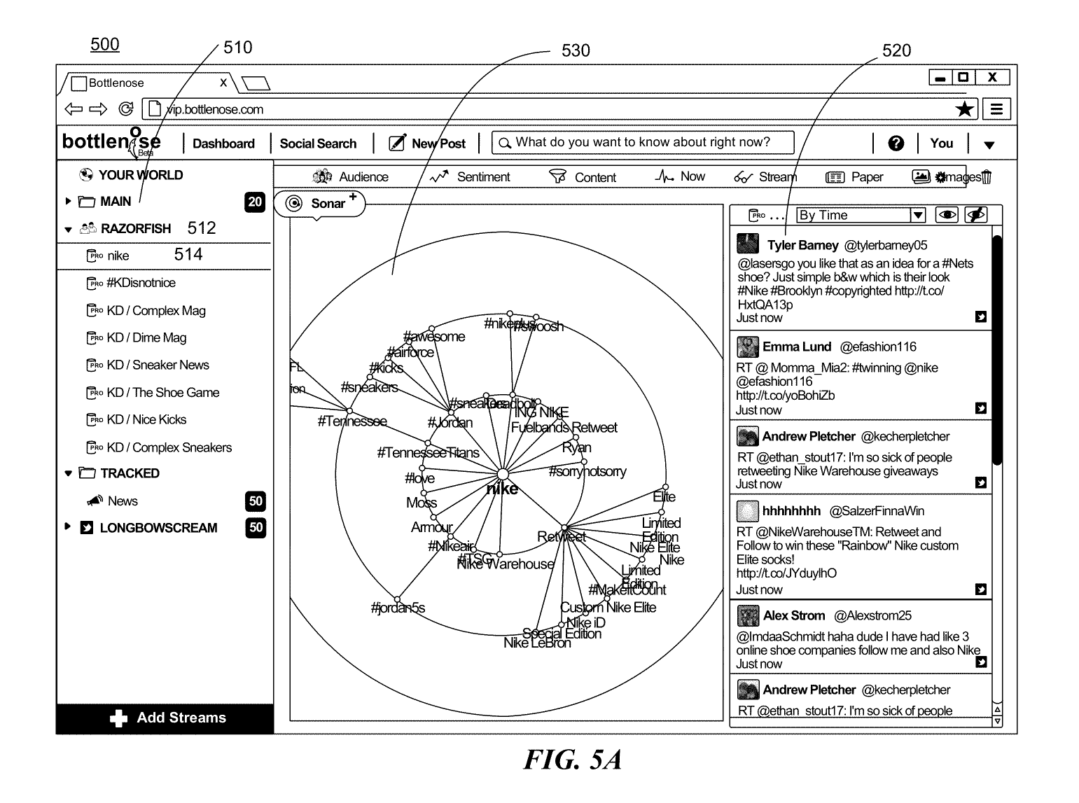

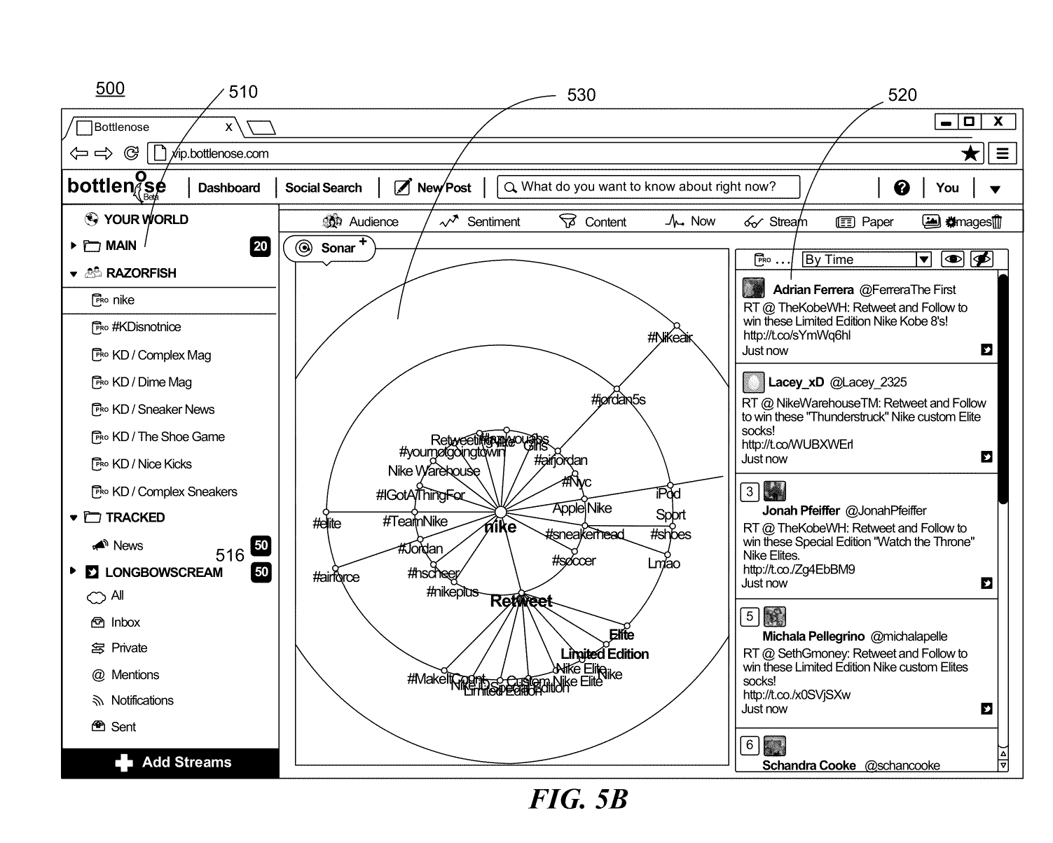

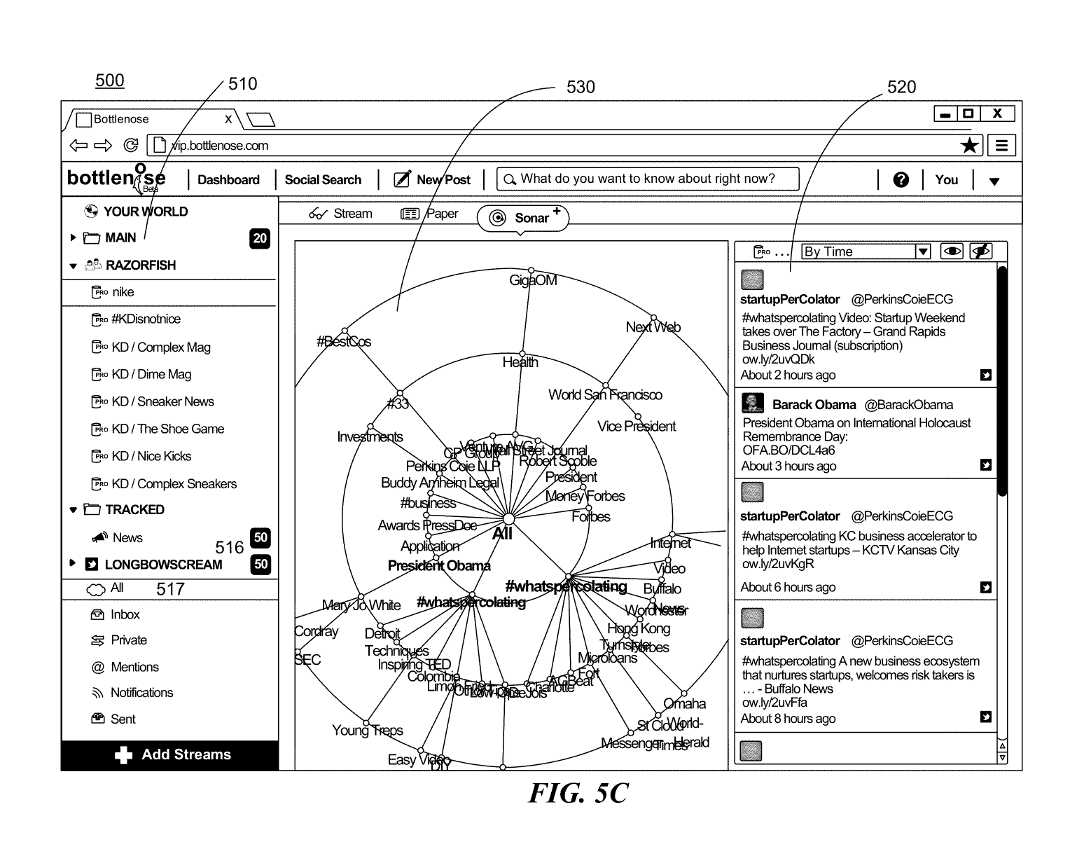

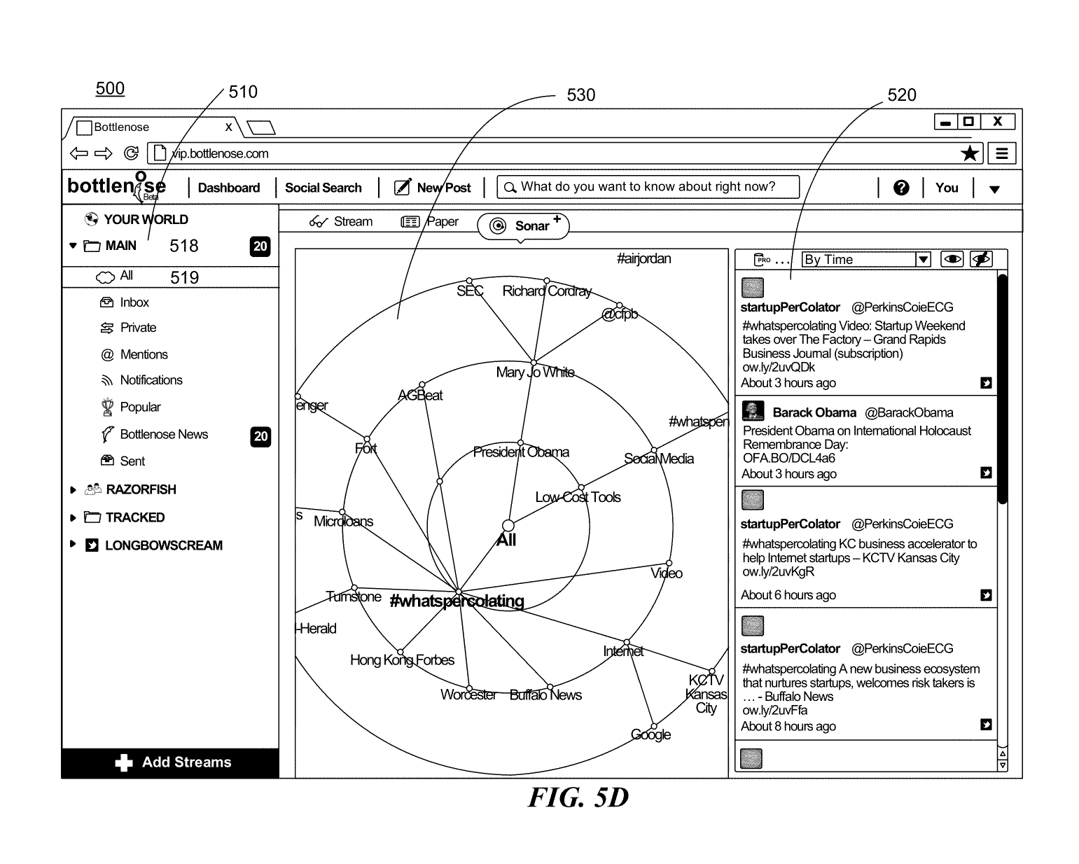

FIG. 5A depicts an example screenshot showing a multiple-panel interface of an enterprise view. The multiple-panel interface 500 includes a menu panel 510. The menu panel 510 includes one or more client accounts, such as the client account 512 named razerfish as shown in FIG. 5A. By clicking a client account 512 in the menu panel, the user can expand the client account 512 to list one or more social media objects to search. The social media objects can include topic keywords, hashtags, or other social media objects that a search can be based upon. The user can click one of the social media object names under the client account 512 to prompt the system to display a trending of associated search results on the stream panel 520 and graphic panel 530.

FIG. 5B depicts an example screenshot showing a multiple-panel interface including an interface for social media account links. As shown in FIG. 5B, the menu panel 510 includes a Twitter account 516. The interface can include more social media account associated with an enterprise client account, such as Facebook or Google Plus accounts. Upon being clicked, the Twitter account 516 can be expand to show more menu items, including all, inbox, private, mentions, notifications and sent. If the user clicks “All” link 517 under the Twitter account 516, as shown in FIG. 5C, the stream panel 520 shows a list of messages for the Twitter account 516. The topics and hashtags of the messages are further organized as nodes and lines figures in the graphic interface 530 to indicate the relationships between the related topics and hashtags. In one embodiment, an enterprise client can link their social media accounts for their brands and sub-brands into the menu panel 510. In another embodiment, an client can link his/her own personal social media accounts into the menu panel 510.

In some embodiment, an agency client can have multiple views of the interface 500 for different account teams for different clients. Within each view of the interface 500, the associated team members will see only the streams and data for the associated client.

FIG. 5D depicts an example screenshot showing a multiple-panel interface including a main folder 518. In one embodiment, the main folder includes an “All” link 519. If the user clicks “All” link 519 under the main folder 518, as shown in FIG. 5D, the stream panel 520 shows a list of messages for all client accounts and social media accounts included in the menu panel 510. The topics and hashtags of the messages are further organized as nodes and lines figures in the graphic interface 530 to indicate the relationships between the related topics and hashtags.

The interface can use different data collection mechanisms based on the types of client account. For instance, for Pro level client accounts, the system can streams messages and data using firehoses supplied by the social media sites such as Twitter or Facebook. The firehoses support a larger bandwidth and possibly fast speed. For regular client accounts, the system can streams messages and data using publicly available API supplied by social media sites such as Twitter or Facebook. The cost of these API are low and even free.

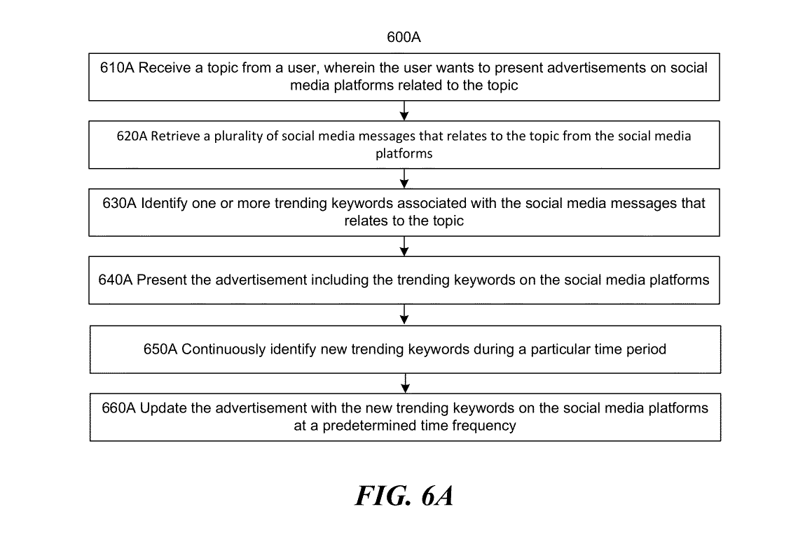

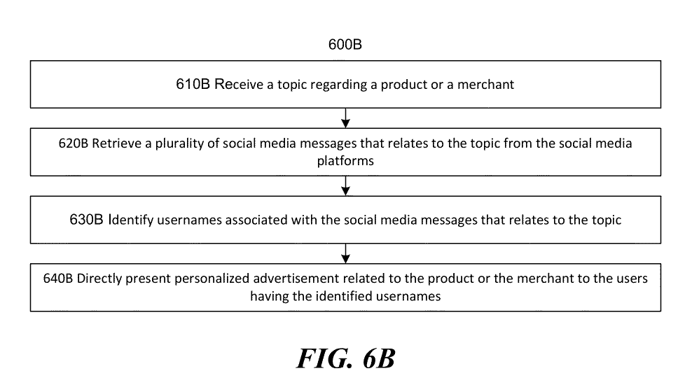

FIG. 6A depicts an example flow chart illustrating an example process 600A for generating keywords to target advertisements. In process 610A, the system receives a topic from a user, wherein the user wants to present advertisements on social media platforms related to the topic. In process 620A, the system retrieves a plurality of social media messages that relates to the topic from the social media platforms.

In process 630A, the system identifies one or more trending keywords associated with the social media messages that relates to the topic. In one embodiment, the trending keywords are keywords mentioned in a high volume of the social media messages, or keywords mentioned by a high volume of users who generates or follows the social media messages. In another embodiment , the process 630A further includes determining a plurality of relationships between the social media messages; and presenting, at a graphic interface, a network diagram including nodes and lines, wherein each individual node of the nodes represents a keyword or hashtag mentioned in the social media objects, and each individual line of the lines represents one of the relationships between two of keywords or hashtags that are represented by two of the nodes being connected by the individual line.

The in process 640A, the system 640A presents the advertisement including the trending keywords on the social media platforms. In process 650A, the system continuously identifies new trending keywords during a particular time period. In one embodiment, the topic is an event that occurs in a particular time period. In process 660A, the system updates the advertisement with the new trending keywords on the social media platforms at a predetermined time frequency.

The process 600A can be used for target advertisements. For instance, the system can generate keywords or phrases and or usernames to target advertisements to. For example, a client wants to target promotion tweets on Twitter for the topic “NFL,” the system conducts a trending search for the topic “NFL.” Following the process 600A, terms that are trending (e.g. high and or sustained volume of mentions and or number of people mentioning over time) are identified. They then select sets of these trending terms or keywords that fit client's target and campaign. The selected trending keywords are fed into the targeting of client's promotion tweets on Twitter. The result is targeting the promotion tweets to the optimal topics around NFL right now. The system then continuously conduct trending search for the topic “NFL” and updates the targeting of their promotion tweet every 2 minutes with new trending keywords during a game for example, which cause the promotion tweets to “follow” the changing topics of conversation in realtime during an event like a NFL game. As some topics rise and others fall, the system is able to optimally target promotion campaign to the rising or hottest topics and not the declining or lower volume topics. The system using process 600A enables an advertiser to cause their campaign to appear at the peaks not the valleys during an event, which optimizes their advertisement targeting.

In some embodiments, the system can further suggest other keywords that relate to NFL but cost less than using topic keyword NFL, and yet to reach the same or even a larger audience. This can be used to optimize advertisement spending and audience reach. This can also be used to buy ahead of the curve because the system can see what topics are gaining popularity but not yet expensive to use. This can be used for advertisement arbitrage as well.

FIG. 6B depicts an example flow chart illustrating an example process 600B for directly targeting advertisements to users. In process 610B, the system receives a topic regarding a product or a merchant. In process 620B, the system retrieves a plurality of social media messages that relates to the topic from the social media platforms.

In process 630B, the system identifies usernames associated with the social media messages that relates to the topic. In one embodiment, the usernames are identified as trending keywords for the social media messages. In process 640B, the system directly presents personalized advertisement related to the product or the merchant to the users having the identified usernames. In one embodiment, the system directly replies to social media messages of the users having the identified usernames with personalized advertisement related to the product or the merchant.

For instance, the process 630B can be used to identify trending usernames for advertisement targeting and enables direct response and targeted offers to users of these usernames. The system can identify users who is talking about a merchant or products that a merchant sells or needs the addresses of the merchant. The system can send the users automatic personalized offers (e.g. by replying to their messages). The system can even see what store the users are near by getting the geographic locations of their tweets (or messages of other social media platform) and send them coupons or promotions for that nearby store.

In another embodiment, the system can also use the system to profile a particular person. Using the system to analyze the stream of messages posted by a person, the system builds a full interest graph for that person: a map of the topic trends, and people they mention, in the messages. This can be used to further target and personalize advertisement and offers to a particular person or user identity in a social network.

The processes 630A and 640B can apply to social network platforms other than Twitter, such as Facebook, Google plus, discussion boards, and blogs.

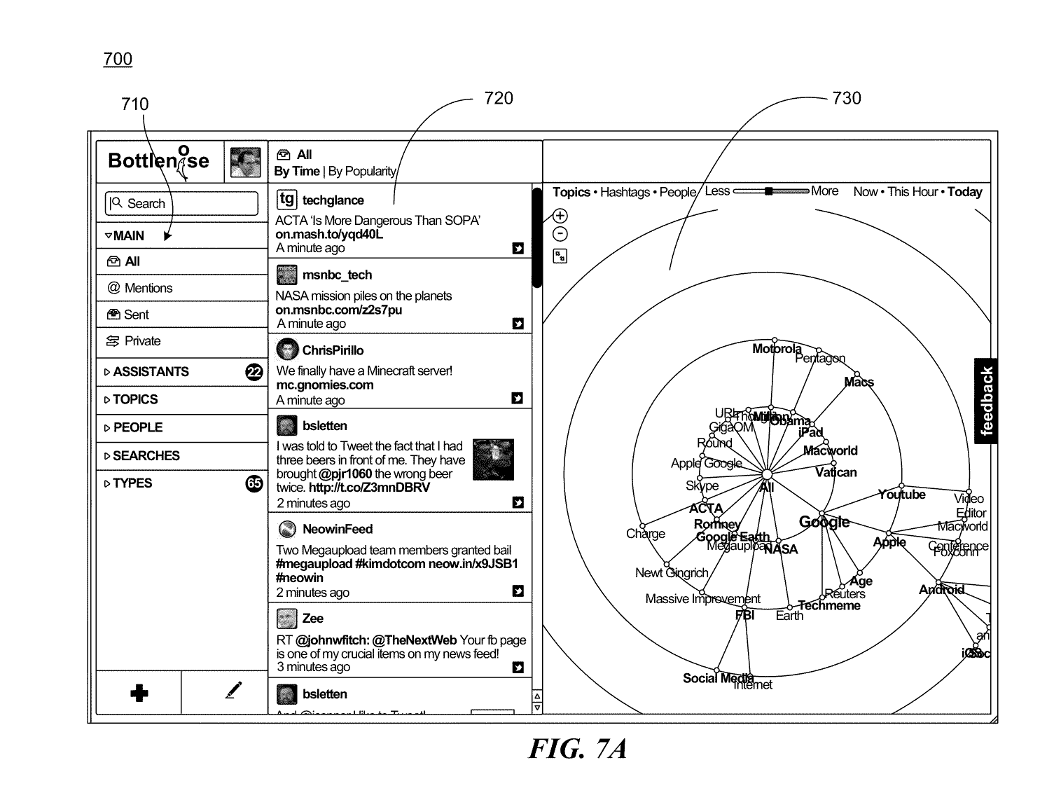

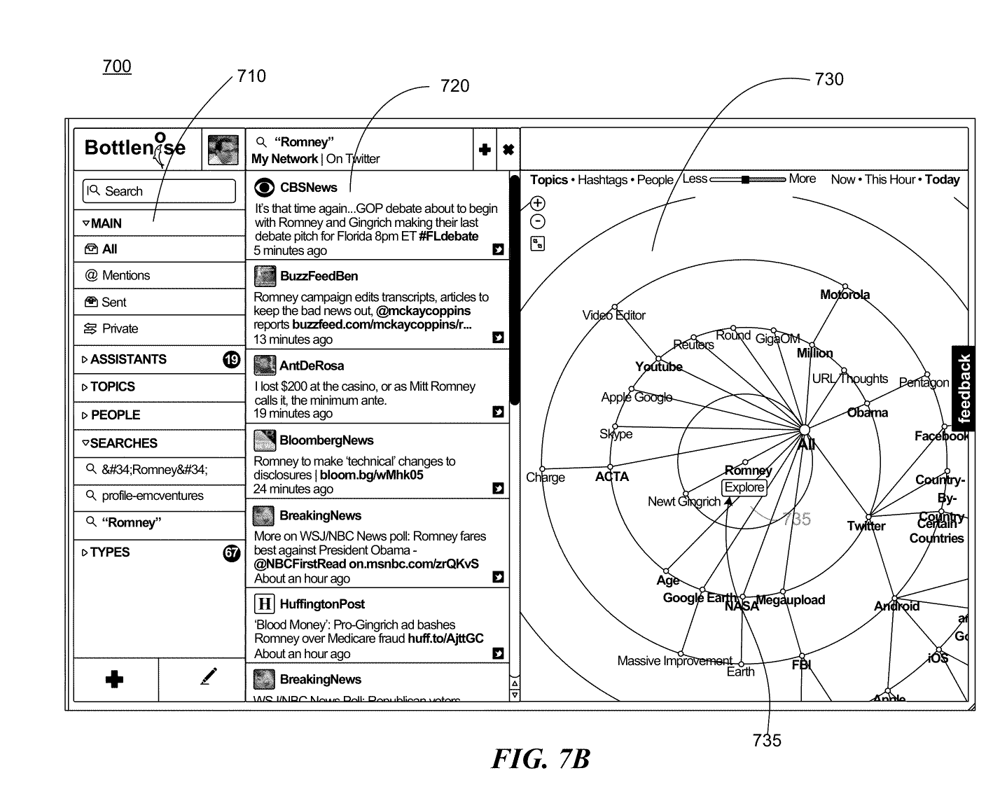

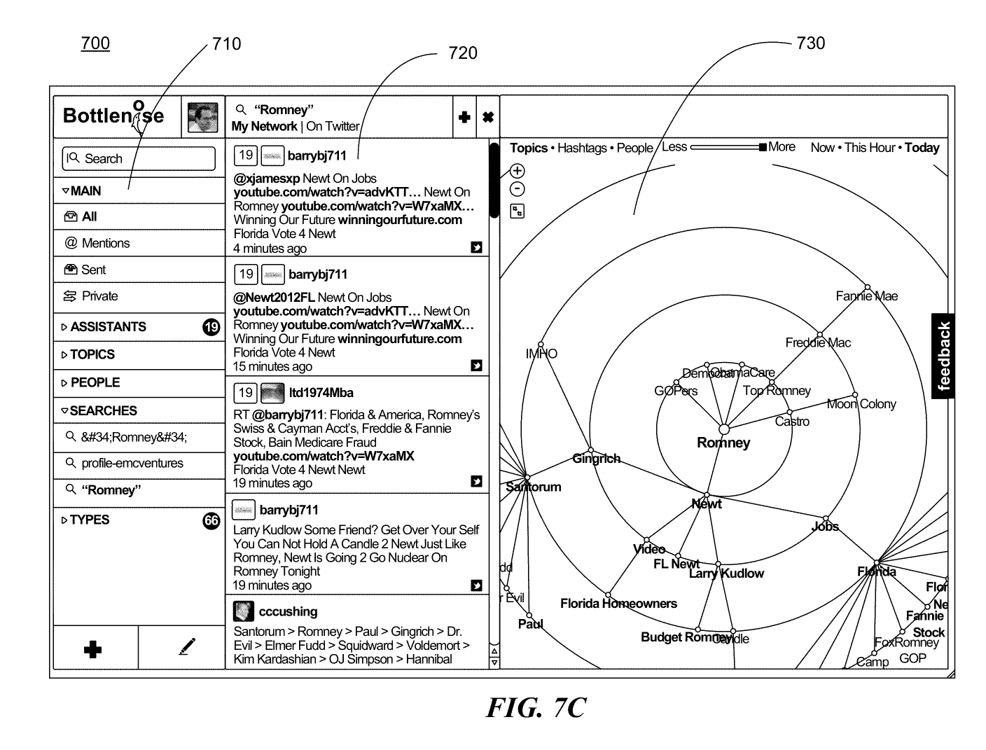

FIG. 7A depicts an example screenshot showing a multi-panel interface for displaying the trending of aggregated personalized information streams. The multi-panel information aggregation interface 700 includes a menu panel 710 for displaying menu interface for the user. For example, the menu panel 710 provides links to display various contents including social media topics, people who are connected with the user in social media sites, searches that the user has conducted in the social media sites. The multi-panel interface 700 further includes a stream panel 720 for displaying aggregated personalized information streams from various social media sites. In one embodiment, the stream panel 720 displays social media contents that are related to the user and people in the user's network. The menu panel 710 provides a mechanism for user to determine how the aggregated personalized information streams are visualized in the stream panel 720. For instance, the user can click a “Mentions” link to instruct the stream panel 720 to display only social media contents that mention the user or the user's posts. The user can click a “Sent” link to instruct the stream panel 720 to display only the contents that are generated by the user and sent to the social media sites. The user can further click a “Private” link to instruct the stream panel 720 to display only private messages that the user has sent or receives. The stream panel 720 provides an interface for the user to browse information from multiple social media sites in a single place.

The multi-panel interface 700 further includes a graphical panel 730 (also referred to as sonar panel) for displaying the aggregated personalized information streams in a multi-dimensional graphical interface. The graphical panel 730 can show multiple layers of information, including social media topics, hashtags, keywords, messages ,or people. A hashtag is a word or a phrase prefixed with the pound sign #, a form of metadata tag. Also, short messages on microblogging social networking services such as Twitter or Google+may be tagged by including one or more with multiple words concatenated. Hashtags provide a means of grouping such messages, since one can search for the hashtag and get the set of messages that contain it. The graphical panel 730 can include other types of layers. For instance, advertisements and other calls to action can be visualized in the graphical panel 730 as a layer for contextual advertising.

In the graphical panel 730, each piece of information is displayed as a node. Lines between the nodes are visualized as indicating the relationships between the nodes. For instance, an advertisement node representing an advertisement can be connected with a topic node representing a social media topic, and the line between these two nodes indicates that the advertisement is related to the social media topic.

The multi-panel interface 700 ties the graphical panel 730 to the stream panel 720 for a side by side integrated browsing experience. A user can move through the node-and-line graph in the graphical panel 730 by clicking on the nodes displaying in the graphical panel 730. As user clicks a node, the graphical panel refreshes the node-and-line graph as showing the clicked node as the focus. Accordingly, the stream panel 720 refreshes the information streams to focus on the social media topic represented by the clicked node. A user can drill into certain social media topics by continuing click on related nodes to discover more about the topic. The stream panel 720 continues to present social media contents that are relevant to the topics represented by the clicked nodes in graphical panel 730.

In some embodiments, such as interface can be visualized by certain types of interfaces other than multiple panels. For instance, the interfaces for displaying the information streams and the node-and-line graph can be combined into a single display region, as readily appreciated by a person having ordinary skill in the art.

In some embodiments, the multiple-panel interface 700 can further includes advertisements in the graphical panel 730. For instance, when a user clicks a node representing a topic, the graphical panel 730 can further visualized connected nodes representing related topics, as well as related advertisements.

FIG. 7B depicts an example screenshot showing the information aggregation interface with advertisements. When a user clicks on a “Romney” node visualized in a graphical panel 730 of the information aggregation interface 700, indicating that the user is interested in topics related to Romney, the information aggregation interface 700 visually updates a stream panel 720 to show social media messages from people who are in the user's network (e.g. people who the user follows in the social media sites) that relate to the topic “Romney.” In the graphical panel 730, the information aggregation interface 700 displays an “Explore” button 735 under the “Romney” node. If the user clicks the “Explore” button 735, the information aggregation interface 700 displays social media messages from all people (instead of people who are in the user's network) about Romney in the stream panel 720, as shown in FIG. 7C. The context of the steam panel has switched from “My Network” to “On Twitter” which reflects that fact that the search of social network messages is now broader. The search is not restricted to people within the user's network, but to all persons of the Twitter social network site or other social network sites. The graphical panel 730 is also updated based on information from the broader scope of all persons of social network cites.

The “Explore” button for switching from “My Network” to “On Twitter” (or “All Networks” or “Everyone”) is optional. In another embodiment, the information aggregation interface 700 can automatically switches to “On Twitter” or “All Networks” when a user clicks a node. In yet another embodiment, the user can decide to change between the “My Network” scope and “All Networks” scope by manually clicking the “My Network” or “All Networks” links on the stream panel. The social media sites can include Twitter, Facebook, Google and other social media sources.

When a user clicks a specific message displayed in the stream panel 720, additional nodes representing detailed information about the specific message appear in the graphical panel 730. Nodes representing different types of messages, such as events or videos, can be visualized in the graphical panel 730. Plugins or specific rules can add functionalities to the graphical panel for specific types of message. For instance, in one embodiment, a node representing an event can include a tab showing a calendar. In another embodiment, a node representing a topic regarding a place can include a pane having a map showing the geographic location of the place. In yet another embodiment, a node representing a topic regarding a video can include a video player pane showing the video. In still another embodiment, a node representing a message containing a web link can show a preview of the webpage with an excerpt of the webpage. In yet still another embodiment, a node representing a topic about a stock can show a chart of the stock. In still yet another embodiment, a node representing a topic about a product can include a “BUY IT” button or a catalog widget for listing related products.

The information aggregation interface 700 can retrieve data stream from various types of social media. The information aggregation interface 700 can retrieve data stream from conventional social media websites, emails, or even from search engines such as Google Search. The graphical panel 730 can show nodes representing messages, search results, or activity stream updates from different data sources.

In another embodiment, a button visualized under the node can be an advertisement link. For example, instead of the “Explore” button, the information aggregation interface 700 can display a “Donate” button as an advertisement for Romney campaign. In some other embodiments, an icon, a link or other types of symbols can be visualized as advertisements related to the topic represented by the node.

Furthermore, the information aggregation interface 700 can visualize advertisements nodes representing advertisements related to the topics. For example, the graphical panel 730 displays a “Hawaii” node as the center node which the user focuses by clicking the node. The graphical panel 730 can further visualized nodes connected to the “Hawaii” node, these nodes representing what people say about Hawaii. Furthermore, the graphical panel 730 can contain nodes representing paid advertisements. For instance, a “Best Hotel in Maui” node can be visualized and connected to the “Hawaii” node. When a user clicks the “Best Hotel in Maui” node, the link can prompt the web browser to launch an external website showing the advertiser's list of hotels in Maui. The link can also show a set of results in the stream panel 720 as paid search or lead-generation results. The link can also prompt the browser to replace the graphical penal 730 with page listing the hotels in Maui. The link can also prompt the browser to pup up an advertisement window over the graphical penal 730, or a new browser window or tab, for displaying the advertisement with hotels in Maui. Similarly, a “Discount Flights to Hawaii” node can be visualized and connected to the “Hawaii” node. If a user clicks the node, the information aggregation interface 700 can visualize the advertisement in various ways as disclosed previously.

The graphical panel 730 can includes additional layers of data beyond people, topics, and hashtags. For instance, the graphical panel 730 can include a types layer that shows types of messages or objects in the current query or context. Types are types of resources (e.g. photo, video, event, questions). The front size of the type label of the node representing the type indicates the approximate number or frequency of results of that type in the context.

In one embodiment, the graphical panel 730 can also appear with a different visualization other than nodes connected by lines. For instance, the graphical panel 730 can visualize as a topographic map, a heatmap, a 3D space, or a tsunami list (i.e. an alphabetical list of tags where each tag is sized relative to the others to indicate relative number of results). Variations of types of visualization can be used to display the aggregated data from social media.

In one embodiment, the information aggregation system includes instances of browser toolbars. A toolbar is installed in a user's browser. The toolbar track user activities as the user searches, reads web pages, visits and interacts with various web cites. The toolbar provides information about the context the user experiences and enables the user to interacts with the information aggregation system. For instance, the user can take actions such as sharing an object that the user is browsing, commenting on an object, annotating an object, or bookmarking an object. When the user launches an external URL with a browser having the toolbar, the browser can frame the webpage of that URL within a layout controlled by the toolbar in the browser. The browser renders the webpage within an interface controlled by the toolbar of the information aggregation system. When a user reads the webpage of that URL, the user can quickly get back to the information aggregation interface by interacting with the toolbar.

The toolbar works as a smart assistant as the user browses on the web. The toolbar collects information about the user, as it pulls in the user's social graphs, messages, and creates graphic presentation of the information to the user in an graphic interface. As the user continues to browses with the toolbar, the toolbar continue to learn about the user, including what the user posts, who the user interacts with, what the user likes, what the user clicks on, etc. The toolbar likes a portable knowledge wallet and a social layer for the user; it augments and annotates the user's experience. The toolbar helps the user as the user uses social media, as the user searches, even as the user browses people or web pages. The information aggregation system not only shows the user related trends, people and other related information, but also provides personal assistance to help the user with what the user is doing.

When a user launches an external webpage from a message, instead of launching a new browser window rendering the webpage, the browser can launch the webpage in a content view frame. In one embodiment, the content view frame takes the place of the graphical view interface in the three-panel information aggregation interface. The user does not need to leave the information aggregation system to read a web page. When a document with a URL is displayed in the content view frame, the stream view interface can show messages containing the URL. The effect is that when a user is browsing the webpage of the URL, the user can also see the real-time discussion messages regarding the webpage in the stream view interface within the same browser window. In one embodiment, the content view frame shows a “Full Size” button. If a user clicks the “Full Size” button, the browser will minimize all other interfaces and frames to the toolbar and maximize the content view frame within the browser window.

The toolbar can have an “Expand” button to expand the interfaces and frames back to the browser again. Optionally, the toolbar include a “Close Toolbar” button to close the Toolbar. Before closing, the toolbar may pop up a window asking “Do you want to open the toolbar interface in another tab?” The user has the discretion to leave the toolbar open or close it. With the toolbar, the information aggregation system works as a meta-data frame around the pages that the user is reading.

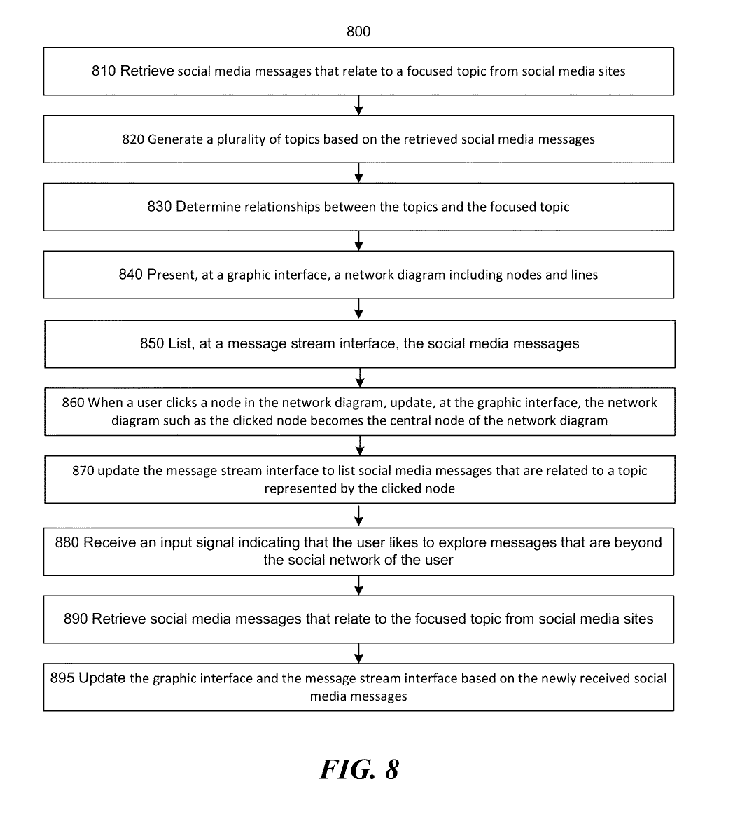

FIG. 8 depicts an example flow chart illustrating an example process for aggregating social media data and presenting a trending of the related social media data. In process 810, a social media information aggregation system retrieves a plurality of social media messages that relate to a focused topic from social media sites. In one embodiment, the retrieved social media messages are generated or followed by people who are within a social network of a user.

In process 820, the system generates a plurality of topics based on the retrieved social media messages. The topics include keywords, key phrases, hashtags, or identifications of people. In process 830, the system determines a plurality of relationships between the topics and the focused topic. In process 840, the system presents, at a graphic interface, a network diagram including nodes and lines. Each individual node of the nodes represents one of the topics and the focused topic. Each individual line of the lines represents one of the relationships between two of the topics and the focused topic that are represented by two of the nodes being connected by the individual line.

In process 850, the system lists, at a message stream interface, the social media messages. In one embodiment, the graphic interface and the message stream interface are within a browser window. In some embodiments, the network diagram is continuously updated when new social media messages are received. In process 860, when a user clicks a node in the network diagram, the system updates, at the graphic interface, the network diagram such as the clicked node becomes the central node of the network diagram. In process 870, the system updates the message stream interface to list social media messages that are related to a topic represented by the clicked node.

In process 880, the system receives an input signal indicating that the user likes to explore messages that are beyond the social network of the user. In process 890, the system retrieves social media messages that relate to the focused topic from social media sites. The received social media messages can be either related or unrelated to the people who are within the social network of the user. In process 895, the system updates the graphic interface and the message stream interface based on the newly received social media messages.

Note that trending can be performed computing or generating momentum, or a score for a keyword, phrase or any combination of words. The score or momentum can be generated by, for example, one or more of, number of mentions of keyword, or number of mentions of keyword per unit time (“volume”), volume*number or unique people mentioning it or number of unique people that mention it per unit time (“uniques”).

By defining a stream to aim sonar at the disclosed system can obtain or identify keywords for a particular audience. For example, the system can define or identify a query to obtain, retrieve, or identify a stream of tweets or other comments about Nike from a region (e.g., in Los Angeles, in Berlin or in New York), and/or in English, and/or by Asian women, and/or with Klout scores above 20. The keywords that are identified as trending in a stream can be utilized to targeting audiences with specified parameters.

In one embodiment, keywords or phrases can be weighted by acceleration of mentions (e.g. change in “volume:) and/or acceleration of “uniques,” per unit time. In one embodiment, a keyword, phrase, or combination of words, can be weighted or scored by the total “audience” size of people who see it. When someone mentions term x, the system can assume that their followers receive it. By aggregating or factoring into the followers of all people mentioning keyword or phrase x and that can be used to compute the total audience that sees or may see the keyword, phrase, or combination of words. This can be referred to as the reach or impressions of the keyword or phrase which corresponds to the number of people who will potentially see the messages containing the keyword or phrase.

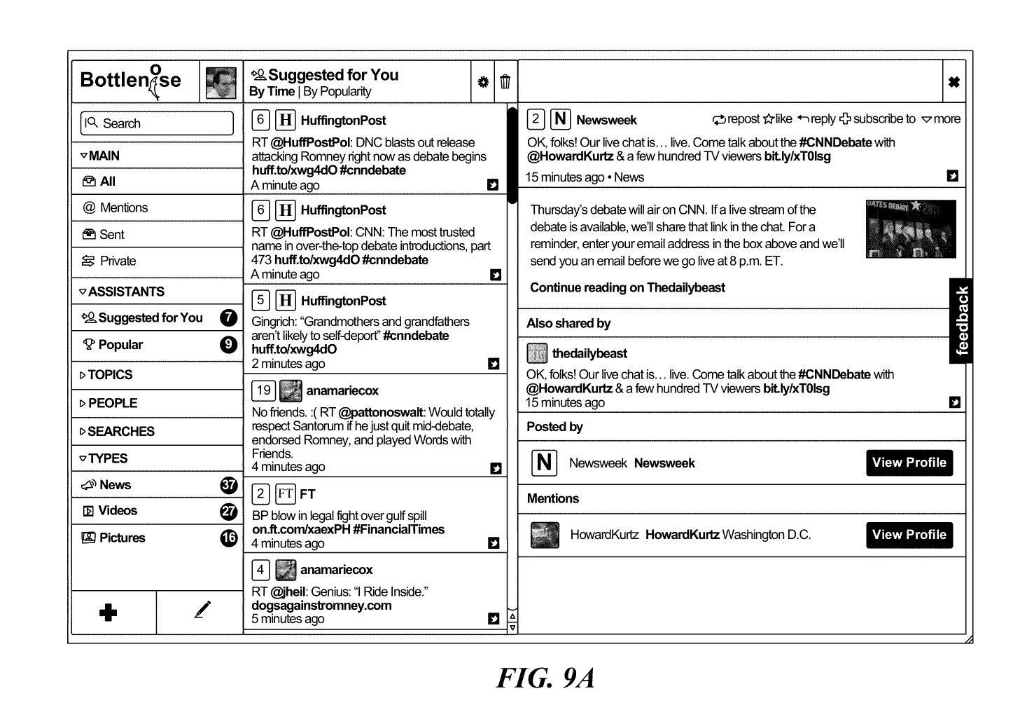

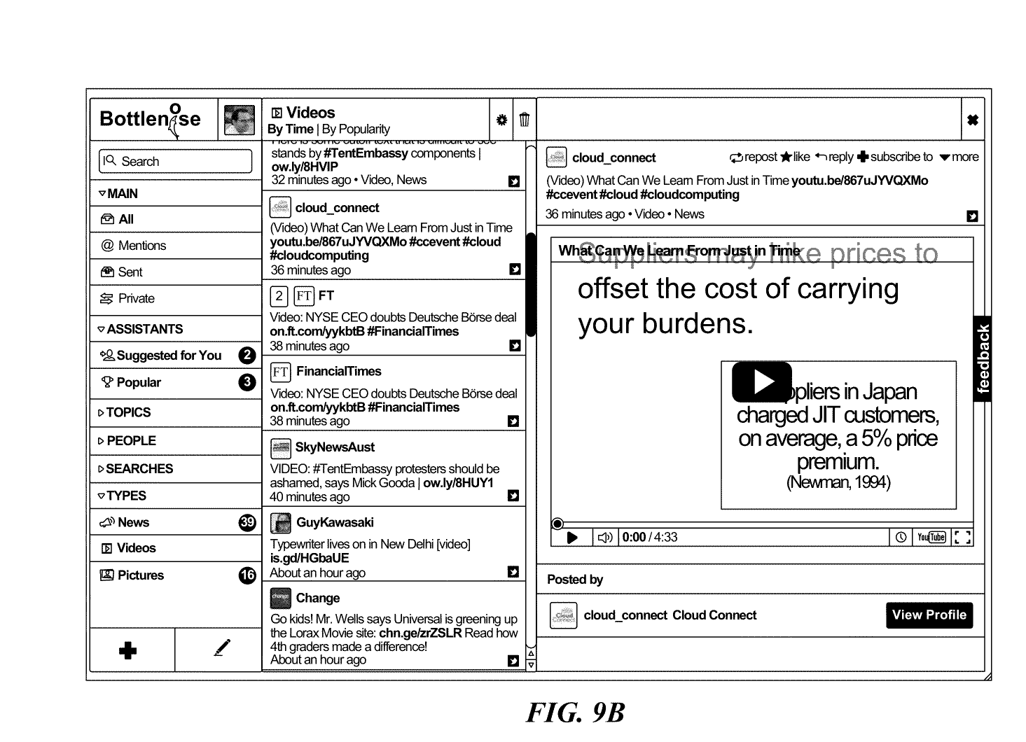

FIG. 9A depict an example screenshot showing that additional details of a message appear in the right pane when a user clicks the specific message in the stream interface. For instance, when a user clicks a message citing a web page in the middle panel, the right panel will visualize the whole message and an abstract and a link of the cited webpage. Optionally an image from the webpage can also be visualized inside the right panel. The right panel can further displays the username and messages that shares the web page or mentions the web page.

FIG. 9B depict an example screenshot showing that a video appears in the right pane when a user clicks a specific message regarding the video in the stream interface. For instance, when a user clicks a link for a message containing a video link in the middle panel, the right panel will visualize a section playing the video from a video content provider site, such as YouTube. The user can further control the video playing by interacting with the video section.

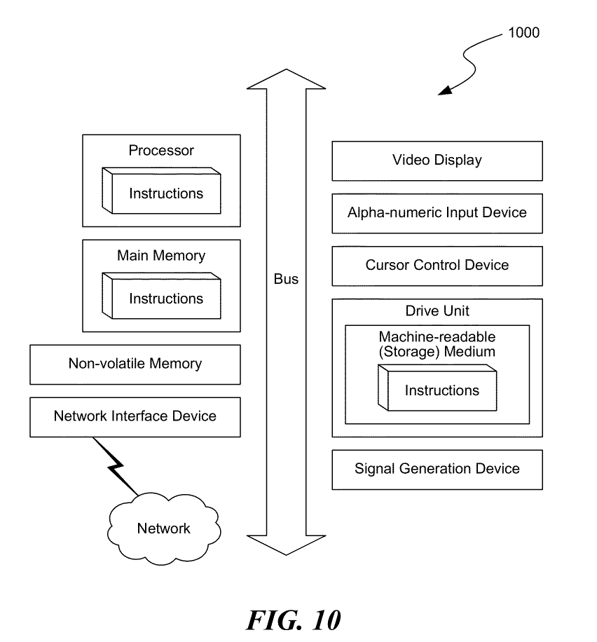

FIG. 10 shows a diagrammatic representation of a machine in the example form of a computer system within which a set of instructions, for causing the machine to perform any one or more of the methodologies discussed herein, may be executed.

In alternative embodiments, the machine operates as a standalone device or may be connected (e.g., networked) to other machines. In a networked deployment, the machine may operate in the capacity of a server or a client machine in a client-server network environment, or as a peer machine in a peer-to-peer (or distributed) network environment.

The machine may be a server computer, a client computer, a personal computer (PC), a user device, a tablet PC, a laptop computer, a set-top box (STB), a personal digital assistant (PDA), a cellular telephone, an iPhone, an iPad, a Blackberry, a processor, a telephone, a web appliance, a network router, switch or bridge, a console, a hand-held console, a (hand-held) gaming device, a music player, any portable, mobile, hand-held device, or any machine capable of executing a set of instructions (sequential or otherwise) that specify actions to be taken by that machine.

While the machine-readable medium or machine-readable storage medium is shown in an exemplary embodiment to be a single medium, the term “machine-readable medium” and “machine-readable storage medium” should be taken to include a single medium or multiple media (e.g., a centralized or distributed database, and/or associated caches and servers) that store the one or more sets of instructions. The term “machine-readable medium” and “machine-readable storage medium” shall also be taken to include any medium that is capable of storing, encoding or carrying a set of instructions for execution by the machine and that cause the machine to perform any one or more of the methodologies of the presently disclosed technique and innovation.

In general, the routines executed to implement the embodiments of the disclosure, may be implemented as part of an operating system or a specific application, component, program, object, module or sequence of instructions referred to as “computer programs.” The computer programs typically comprise one or more instructions set at various times in various memory and storage devices in a computer, and that, when read and executed by one or more processing units or processors in a computer, cause the computer to perform operations to execute elements involving the various aspects of the disclosure.

Moreover, while embodiments have been described in the context of fully functioning computers and computer systems, those skilled in the art will appreciate that the various embodiments are capable of being distributed as a program product in a variety of forms, and that the disclosure applies equally regardless of the particular type of machine or computer-readable media used to actually effect the distribution.

Further examples of machine-readable storage media, machine-readable media, or computer-readable (storage) media include, but are not limited to, recordable type media such as volatile and non-volatile memory devices, floppy and other removable disks, hard disk drives, optical disks (e.g., Compact Disk Read-Only Memory (CD ROMS), Digital Versatile Disks, (DVDs), etc.), among others, and transmission type media such as digital and analog communication links.

The network interface device enables the machine 1100 to mediate data in a network with an entity that is external to the host server, through any known and/or convenient communications protocol supported by the host and the external entity. The network interface device can include one or more of a network adaptor card, a wireless network interface card, a router, an access point, a wireless router, a switch, a multilayer switch, a protocol converter, a gateway, a bridge, bridge router, a hub, a digital media receiver, and/or a repeater.

The network interface device can include a firewall which can, in some embodiments, govern and/or manage permission to access/proxy data in a computer network, and track varying levels of trust between different machines and/or applications. The firewall can be any number of modules having any combination of hardware and/or software components able to enforce a predetermined set of access rights between a particular set of machines and applications, machines and machines, and/or applications and applications, for example, to regulate the flow of traffic and resource sharing between these varying entities. The firewall may additionally manage and/or have access to an access control list which details permissions including for example, the access and operation rights of an object by an individual, a machine, and/or an application, and the circumstances under which the permission rights stand.

Other network security functions can be performed or included in the functions of the firewall, can be, for example, but are not limited to, intrusion-prevention, intrusion detection, next-generation firewall, personal firewall, etc. without deviating from the novel art of this disclosure.

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” As used herein, the terms “connected,” “coupled,” or any variant thereof, means any connection or coupling, either direct or indirect, between two or more elements; the coupling of connection between the elements can be physical, logical, or a combination thereof. Additionally, the words “herein,” “above,” “below,” and words of similar import, when used in this application, shall refer to this application as a whole and not to any particular portions of this application. Where the context permits, words in the above Detailed Description using the singular or plural number may also include the plural or singular number respectively. The word “or,” in reference to a list of two or more items, covers all of the following interpretations of the word: any of the items in the list, all of the items in the list, and any combination of the items in the list.

The above detailed description of embodiments of the disclosure is not intended to be exhaustive or to limit the teachings to the precise form disclosed above. While specific embodiments of, and examples for, the disclosure are described above for illustrative purposes, various equivalent modifications are possible within the scope of the disclosure, as those skilled in the relevant art will recognize. For example, while processes or blocks are presented in a given order, alternative embodiments may perform routines having steps, or employ systems having blocks, in a different order, and some processes or blocks may be deleted, moved, added, subdivided, combined, and/or modified to provide alternative or subcombinations. Each of these processes or blocks may be implemented in a variety of different ways. Also, while processes or blocks are at times shown as being performed in series, these processes or blocks may instead be performed in parallel, or may be performed at different times. Further, any specific numbers noted herein are only examples: alternative implementations may employ differing values or ranges.

The teachings of the disclosure provided herein can be applied to other systems, not necessarily the system described above. The elements and acts of the various embodiments described above can be combined to provide further embodiments.

Any patents and applications and other references noted above, including any that may be listed in accompanying filing papers, are incorporated herein by reference. Aspects of the disclosure can be modified, if necessary, to employ the systems, functions, and concepts of the various references described above to provide yet further embodiments of the disclosure.

These and other changes can be made to the disclosure in light of the above Detailed Description. While the above description describes certain embodiments of the disclosure, and describes the best mode contemplated, no matter how detailed the above appears in text, the teachings can be practiced in many ways. Details of the system may vary considerably in its implementation details, while still being encompassed by the subject matter disclosed herein. As noted above, particular terminology used when describing certain features or aspects of the disclosure should not be taken to imply that the terminology is being redefined herein to be restricted to any specific characteristics, features, or aspects of the disclosure with which that terminology is associated. In general, the terms used in the following claims should not be construed to limit the disclosure to the specific embodiments disclosed in the specification, unless the above Detailed Description section explicitly defines such terms. Accordingly, the actual scope of the disclosure encompasses not only the disclosed embodiments, but also all equivalent ways of practicing or implementing the disclosure under the claims.

While certain aspects of the disclosure are presented below in certain claim forms, the inventors contemplate the various aspects of the disclosure in any number of claim forms. For example, while only one aspect of the disclosure is recited as a means-plus-function claim under 35 U.S.C. §112, ¶6, other aspects may likewise be embodied as a means-plus-function claim, or in other forms, such as being embodied in a computer-readable medium. (Any claims intended to be treated under 35 U.S.C. §112, ¶6 will begin with the words “means for”.) Accordingly, the applicant reserves the right to add additional claims after filing the application to pursue such additional claim forms for other aspects of the disclosure.

what is claimed is:

1. A method for visualizing social media data comprising:
retrieving a plurality of social media objects that relates to a focused social media object from social media sites;
determining a plurality of relationships between the social media objects; and
presenting, at a graphic interface, a network diagram including nodes and lines, wherein each individual node of the nodes represents one of the social media objects, and each individual line of the lines represents one of the relationships between two of the social media objects that are represented by two of the nodes being connected by the individual line.

2. The method of claim 1, wherein the nodes include a central node that represents the focused social media object of the social media objects.

3. The method of claim 1, further comprising:
receiving an input signal indicating that a user clicks a node of the nodes; and
refreshing, at the graphic interface, the network diagram such that the clicked node becomes a central node and the network diagram includes nodes that relates to the central node.

4. The method of claim 1, wherein the social media objects includes topics, hashtags, keywords, messages, emails, search results, or people.

5. The method of claim 1, wherein the graphic interface is at least a portion of a webpage rendered by a computer device.

6. The method of claim 1, further comprising:
listing, at a message stream interface, abstracts of the social media objects; and
updating the message stream interface by listing abstracts of social media objects that relate to one individual social media object of the social media objects, when a user clicks a node representing the individual social media object in the network diagram.

7. The method of claim 6, further comprising: refreshing, at the graphic interface, the network diagram such that the node representing the individual social media object becomes a central node and the network diagram includes nodes representing the social media objects that relate to the individual social media object.

8. The method of claim 6, wherein the social media objects listed in the message stream interface are messages that relate to the individual social media object and are generated or followed by people who are within a social network of the user.

9. The method of claim 1, further comprising:
receiving an input signal indicating that a user likes to explore more information about one individual social media object of the social media objects;
retrieving related social media objects that relate to the individual social media object from the social media sites; and
refreshing, at the graphic interface, the network diagram such that the network diagram include a central node representing the individual social media object and nodes representing the related social media objects.

10. The method of claim 9, wherein the input signal is triggered by the user clicking a button associated to the individual social media object.

11. The method of claim 9, wherein the graphic interface is continuously updated as the related social media objects are continuously retrieved from the social media sites.

12. The method of claim 9, further comprising: listing, at the message stream interface, messages that relate to the individual social media object regardless of whether the messages are generated or followed by people who are within a social network of the user or not.

13. The method of claim 1, further comprising: displaying, at the graphic interface, statistics information regarding a node when cursor moves over the node, wherein the statistics information includes a number of people mentioning a topic represented by the node, a number of messages mentioning the topic represented by the node, or a time frame when the topic represented by the node is mentioned.

14. The method of claim 1, wherein the network diagram further includes circles enclosing a central node representing the focused social media object, for each individual circle of the circles, the distance between the individual circle and the central node indicates a closeness of relationships between the focused social media object and social media objects represented by nodes located on the individual circle.

15. A method comprising:
retrieving a plurality of social media messages that relate to a focused topic from social media sites;
generating a plurality of topics based on the retrieved social media messages;
determining a plurality of relationships between the topics and the focused topic; and
presenting, at a graphic interface, a network diagram including nodes and lines, wherein each individual node of the nodes represents one of the topics and the focused topic, and each individual line of the lines represents one of the relationships between two of the topics and the focused topic that are represented by two of the nodes being connected by the individual line.

16. The method of claim 15, wherein the topics include keywords, key phrases, hashtags, or identifications of people.

17. The method of claim 15, further comprising: listing, at a message stream interface, the social media messages.

18. The method of claim 17, wherein the graphic interface and the message stream interface are within a browser window.

19. The method of claim 15, wherein the network diagram is continuously updated when new social media messages are received.

20. The method of claim 15, further comprising:
when a user clicks a node in the network diagram, updating, at the graphic interface, the network diagram such as the clicked node becomes the central node of the network diagram.

21. The method of claim 20, further comprising: updating the message stream interface to list social media messages that are related to a topic represented by the clicked node.

22. The method of claim 20, further comprising: requesting social media messages that relates to a topic represented by the clicked node from the social media sites.

23. The method of claim 15, further comprising: zooming in or zooming out the network diagram when a user zoom signal is received.

24. The method of claim 15, wherein the retrieved social media messages are generated or followed by people who are within a social network of a user.

25. The method of claim 24, further comprising:
receiving an input signal indicating that the user likes to explore messages that are beyond the social network of the user; and
retrieving social media messages that relates to the focused topic from social media sites, wherein the social media messages can be unrelated to the people who are within the social network of the user.

26. The method of claim 15, further comprising, generating a score for a keyword or phrase relating to one of the plurality of topics.

27. The method of claim 26, wherein, the score is determined from number of mentions of the keyword or mentions of the keyword per unit time.

28. The method of claim 26, wherein, the score is determined from number of mentions and a number of unique persons that mention it per unit time.

29. The method of claim 26, further comprising weighting the keyword or phrase by a total number of people who will potentially see it based on followers of people in a given social network or across multiple social networks.
